(19) United States
(12) Patent Application Publication
(10) Pub. No.: US 2015/0068903 A1
(43) Pub. Date: Mar. 12, 2015

(54) DROPLET OPERATIONS DEVICE

(71) Applicant: Advanced Liquid Logic, Inc., San Diego, CA (US)

(72) Inventors: Vijay Srinivasan, San Diego, CA (US); Arjun Sudarsan, Carlsbad, CA (US); Vamsee K. Pamula, Durham, NC (US); Michael G. Pollack, San Diego, CA (US); Ramakrishna Sista, Morrisville, NC (US); Raymond Kozikowski, Gainesville, FL (US); Nicole Bell, Apex, NC (US)

(73) Assignee: ADVANCED LIQUID LOGIC, INC., San Diego, CA (US)

(21) Appl. No.: 14/498,418

(22) Filed: Sep. 26, 2014

Related U.S. Application Data
(63) Continuation of application No. 13/003,765, filed on Jun. 10, 2011.
(60) Provisional application No. 61/082,164, filed on Jul. 18, 2008.
(60) Provisional application No. 61/140,707, filed on Dec. 24, 2008.
(60) Provisional application No. 61/141,167, filed on Dec. 29, 2008.
(60) Provisional application No. 61/142,181, filed on Dec. 31, 2008.
(60) Provisional application No. 61/159,197, filed on Mar. 11, 2009.

(51) Int. Cl. G01N 27/447

(52) U.S. Cl. CPC G01N 27/44756
USPC 204/547; 204/643

(57) ABSTRACT

The invention provides droplet actuators with droplet operations surfaces for manipulating droplets, e.g., by conducting droplet operations. The droplet operations surfaces are typically exposed to a droplet operations gap. One or more regions of a droplet operation surface may include patterned topographic features. The invention also provides a droplet actuator in which one or both gap-facing droplet operations surfaces is formed using a removable film. The removable film may, in various embodiments, also include other components ordinarily associated with the droplet actuator substrate, such as the dielectric layer and the electrodes. Further, the invention provides droplet actuator devices and methods for coupling and/or sealing substrates of a droplet actuator, such as techniques for self-aligning assembly of droplet actuator substrates. The invention provides droplet actuators and methods of disassembling the droplet actuator in order to provide access for cleaning and/or recycling of droplet actuator surfaces.

### 1 RELATED APPLICATIONS

This application claims priority to the following U.S. Patent Applications: 61/082,164, entitled “Droplet Actuators with Patterned Surfaces,” filed on Jul. 18, 2008; 61/140,707, entitled “Droplet Actuator Assembly,” filed on Dec. 24, 2008; 61/141,167, entitled “Unit Cells on a Droplet Actuator,” filed on Dec. 29, 2008; 61/142,181, entitled “Unit Cells on a Droplet Actuator,” filed on Dec. 31, 2008; and 61/159,197, entitled “Droplet Actuators with Patterned Surfaces,” filed on Mar. 11, 2009; the entire disclosures of each of these applications is incorporated herein by reference.

### 2 BACKGROUND

Droplet actuators are used to conduct a wide variety of droplet operations. A droplet actuator typically includes one or more substrates configured to form a surface or gap for conducting droplet operations. The one or more substrates include electrodes for conducting droplet operations. The gap between the substrates is typically filled or coated with a filler fluid that is immiscible with the liquid that is to be subjected to droplet operations. Droplet operations are controlled by electrodes associated with the one or more substrates. There is a need for new approaches to guiding, sizing, and shaping droplets in a droplet actuator.

The top and bottom substrates are coupled and sealed to prevent leakage of fluid from the droplet actuator. There is a need for improved methods of attaching and sealing a droplet actuator that provides for quick and easy assembly and disassembly.

Droplet actuators are used in a variety of applications, including diagnostic assays, such as immunoassays and genetic analysis (e.g., polymerase chain reaction (PCR) and pyrosequencing), where time to result is directly affected by the protocols used for each step of the assay. Serial processing of samples on a droplet actuator is time consuming and consequently results in a delay in time to result of a diagnostic assay. Serial processing of samples on a droplet actuator requires transport of droplets along shared droplet operation pathways, a process that may cause cross-contamination between samples. There is a need for improved droplet actuators configured for assays that provide for increased efficiency in performance of a diagnostic assay (e.g., decreased time to result, reduced contamination between samples, and parallel processing).

### 3 BRIEF DESCRIPTION OF THE INVENTION

The invention provides a droplet actuator substrate that may include a base substrate comprising electrodes, an adhesive layer atop the base substrate, a dielectric layer atop the adhesive layer and bound to the base substrate by the adhesive layer, and a droplet operations surface atop the dielectric layer.

The invention also provides a method of making a droplet actuator substrate, the method may include providing a base substrate comprising electrodes, applying an adhesive layer atop the base substrate, and applying a dielectric layer atop the adhesive layer, wherein the adhesive layer binds the dielectric layer to the base substrate and the droplet actuator substrate comprises a droplet operations surface atop the dielectric layer.

Further, the invention provides a droplet actuator that may include a substrate and electrodes underlying a surface of the substrate, wherein the surface of the substrate may include a three dimensional topography comprising features selected to enhance one or more droplet operations on the droplet operations surface.

The invention also provides a droplet actuator that may include a base substrate comprising electrodes and a removable film applied atop the base substrate.

In another method of operating a droplet actuator, the method may include providing a droplet actuator substrate including electrodes configured for conducting one or more droplet operations, applying a removable film atop the droplet actuator substrate to establish a droplet operations surface, conducting one or more droplet operations on the droplet operations surface, and replacing the film atop the droplet actuator substrate to establish a new droplet operations surface.

Further, the invention provides a droplet actuator that may include one or more cartridges, each including a droplet operations substrate and a cover separated from the droplet operation substrate to form a gap configured for conducting droplet operations and at least two assay unit cell configurations associated with the one or more cartridges, wherein each assay unit cell configuration may include electrodes associated with the droplet operations substrate and/or the cover of one or more of the cartridges and arranged for conducting droplet operations, and is associated with one or more reservoirs for loading reagent into the gap for conducting one or more assays using the assay unit cell configuration and one or more openings for loading sample into the gap for conducting one or more assays using the assay unit cell configuration.

The invention also provides a droplet actuator comprising a substrate including electrodes configured for conducting droplet operations on a surface of the substrate wherein the electrodes includes multiplexed electrode sets, wherein each electrode in a set includes a common electrical source, and independently controlled gating electrodes.

The invention additionally provides a method of conducting one or more droplet operations, wherein the method includes providing two or more sets of electrodes and controlling voltage applied to the electrodes to effect a droplet operation, at least one of the electrodes in each of the droplet dispensing electrode configurations is independently electrically controlled, at least two of the electrodes, each in a different one of the droplet dispensing electrode configurations, are commonly electrically controlled, and by controlling the independently electrically controlled electrodes, the completion of the droplet operation in any combination of the sets may be completed or not completed.

The invention yet further provides a method of dispensing a droplet from a set of droplet dispensing electrode configurations, wherein the method includes providing a droplet source, activating a series of two or more electrodes to form a droplet extension from the droplet source, and deactivating an intermediate one of the electrodes to yield a droplet on a terminal one or more of the electrodes, and at least one of the electrodes in each of the droplet dispensing electrode configurations is independently electrically controlled, at least two of the electrodes, each in a different one of the droplet dispensing electrode configurations, are commonly electrically controlled, and by controlling the independently electrically controlled electrodes, any combination of one or more droplets may be dispensed from the set of droplet dispensing electrode configurations in a single dispensing operation.

Further, the invention provides a method of conducting one or more assays, the method including providing a microfluidic cartridge with multiple unit cells, using a first unit cell to conduct a first assay, sealing off the first unit cell, and using a second unit cell to conduct a second assay.

Still further, the invention provides a droplet actuator that may include a bottom substrate, a top substrate separated from the bottom substrate by a gap suitable for conducting one or more droplet operations, at least one spacer between the bottom substrate and top substrate for defining the size of the gap, and at least one opening in the top substrate and a corresponding plated via on the bottom substrate, each opening substantially aligned with the corresponding plated via, and each opening of a size to accommodate a corresponding fastener for having each corresponding fastener secured to a corresponding plated via.

The invention also provides a droplet actuator that may include a bottom substrate, a top substrate separated from the bottom substrate by a droplet operations gap suitable for conducting one or more droplet operations, at least one spacer between the bottom substrate and top substrate for defining the size of the gap, and material regions on the top substrate and on the bottom substrate adapted for soldering, for attaching and sealing the top substrate to the bottom substrate.

The invention additionally provides a droplet actuator including a bottom substrate supported by a bottom plate, the bottom plate having at least one opening, with the bottom substrate supported by the bottom plate in a region defined by the at least one opening, a top substrate separated from the bottom substrate by a gap suitable for conducting one or more droplet operation, at least one spacer between the bottom substrate and top substrate for defining the size of the gap, and at least one fastener on the top substrate corresponding to the at least one opening and aligned therewith for providing self-alignment of the top substrate and the bottom substrate.

### 4 DEFINITIONS

As used herein, the following terms have the meanings indicated.

“Activate” with reference to one or more electrodes means effecting a change in the electrical state of the one or more electrodes which, in the presence of a droplet, results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator or otherwise configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Corp., Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication No. 20050260686, entitled, “Multiplex flow assays preferably with magnetic particles as solid phase,” published on Nov. 24, 2005, the entire disclosure of which is incorporated herein by reference for its teaching concerning magnetically responsive materials and beads. Beads may be pre-coupled with a biomolecule (ligand). The ligand may, for example, be an antibody, protein or antigen, DNA/RNA probe or any other molecule with an affinity for the desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference.

“Droplet” means a volume of liquid on a droplet actuator that is at least partially bounded by filler fluid. For example, a droplet may be completely surrounded by filler fluid or may be bounded by filler fluid and one or more surfaces of the droplet actuator. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids.

“Droplet Actuator” means a device for manipulating droplets. For examples of droplet actuators, see U.S. Pat. No. 6,911,132, entitled “Apparatus for Manipulating Droplets by Electrowetting-Based Techniques,” issued on Jun. 28, 2005 to Pamula et al.; U.S. patent application Ser. No. 11/343,284, entitled “Apparatuses and Methods for Manipulating Droplets on a Printed Circuit Board” filed on filed on Jan. 30, 2006; U.S. Pat. Nos. 6,773,566, entitled “Electrostatic Actuators for Microfluidics and Methods for Using Same,” issued on Aug. 10, 2004 and 6,565,727, entitled “Actuators for Microfluidics Without Moving Parts,” issued on Jan. 24, 2000, both to Shenderov et al.; Pollack et al., International Patent Application No. PCT/US2006/047486, entitled “Droplet-Based Biochemistry,” filed on Dec. 11, 2006; and Roux et al., U.S. Patent Pub. No. 20050179746, entitled “Device for Controlling the Displacement of a Drop Between two or Several Solid Substrates,” published on Aug. 18, 2005; the disclosures of which are incorporated herein by reference. Certain droplet actuators will include a substrate, droplet operations electrodes associated with the substrate, one or more dielectric and/or hydrophobic layers atop the substrate and/or electrodes forming a droplet operations surface, and optionally, a top substrate separated from the droplet operations surface by a gap. One or more reference electrodes may be provided on the top and/or bottom substrates and/or in the gap. In various embodiments, the manipulation of droplets by a droplet actuator may be electrode mediated, e.g., electrowetting mediated or dielectrophoresis mediated or Coulombic force mediated. Examples of other methods of controlling fluid flow that may be used in the droplet actuators of the invention include devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed in droplet actuators of the invention.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Filler fluid” means a fluid associated with a droplet operations substrate of a droplet actuator, which fluid is sufficiently immiscible with a droplet phase to render the droplet phase subject to electrode-mediated droplet operations. The filler fluid may, for example, be a low-viscosity oil, such as silicone oil. Other examples of filler fluids are provided in International Patent Application No. PCT/US2006/047486, entitled, “Droplet-Based Biochemistry,” filed on Dec. 11, 2006; International Patent Application No. PCT/US2008/072604, entitled “Use of additives for enhancing droplet actuation,” filed on Aug. 8, 2008; and U.S. Patent Publication No. 20080283414, entitled “Electrowetting Devices,” filed on May 17, 2007; the entire disclosures of which are incorporated herein by reference. The filler fluid may fill the entire gap of the droplet actuator or may coat one or more surfaces of the droplet actuator. Filler fluid may be conductive or non-conductive.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a splitting operation on a droplet, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Washing” with respect to washing a magnetically responsive bead means reducing the amount and/or concentration of one or more substances in contact with the magnetically responsive bead or exposed to the magnetically responsive bead from a droplet in contact with the magnetically responsive bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix, or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 5 BRIEF DESCRIPTION OF THE DRAWINGS

FIGS. 1A, 1B, and 1C illustrate side views of a process of embossing a pattern into the substrate of a droplet actuator;

FIGS. 2A, 2B, and 2C illustrate side views that show more details of the process of embossing a pattern into the substrate of a droplet actuator;

FIG. 3 illustrates a side view of a section of a droplet actuator that has been patterned via the embossing process of the invention;

FIG. 4 illustrates a side view that shows more details of the droplet actuator of FIG. 3 that has been patterned via the embossing process of the invention;

FIG. 5 illustrates a top view of another example of a droplet actuator that has been patterned via the embossing process of the invention;

FIG. 6 illustrates a side view of yet another example of a droplet actuator in which the top substrate has been patterned via the embossing process of the invention or formed using other available techniques for forming plastics or the like;

FIG. 7 illustrates a side view of a droplet actuator substrate including a base substrate, electrodes, adhesive, dielectric, and hydrophobic coating;

FIGS. 8A and 8B illustrate side views of a section of a droplet actuator and a method of attaching the top and bottom substrates by soldering;

FIGS. 9A, 9B, and 9C illustrate various views of a portion of a droplet actuator and another method for using soldering to couple top and bottom substrates and to seal the droplet actuator;

FIGS. 10A and 10B illustrate side views of a portion of a droplet actuator and a method for using flexible fasteners to couple top and bottom substrates;

FIG. 11 illustrates a top view of a portion of a droplet actuator that has four unit cells and a separate detection cell;

FIG. 12 is a diagram of a droplet actuator that has multiple unit cells, where each unit cell includes its own detection region;

FIG. 13 is a top view of a portion of a droplet actuator that has multiple unit cells, where each unit cell includes an immunoassay cell and a washing cell;

FIGS. 14A through 14D show a top view of a washing cell and a process of washing magnetically responsive beads in a washing cell;

FIGS. 15A and 15B are views of a portion of a droplet actuator that has spiral-shaped unit cells, and as an example, shows a detail illustrating a spiral layout for an immunoassay;

FIG. 16 illustrates a top view of a portion of a droplet actuator that is configured for real-time flow-through PCR;

FIG. 17 illustrates a top view of a portion of a disk-shaped droplet actuator that has wedge-shaped unit cells; and

FIG. 18 illustrates an embodiment of the invention including providing multiplexed electrode configurations with gating electrodes.

### 6 DESCRIPTION

The invention provides droplet actuators with droplet operations surfaces for manipulating droplets, e.g., by conducting droplet operations. The droplet operations surfaces are typically exposed to a droplet operations gap. One or more regions of a droplet operation surface may include patterned topographic features. The patterned topographic features have a variety of advantages relative to a substantially planar droplet operations surface topography. The patterned topographic features may assist in conducting one or more droplet operations, for example, by providing differences in droplet operations gap height within a droplet actuator. For example, patterned topographic features may be used for guiding, sizing, and/or shaping droplets; and/or retaining a droplet in position in a droplet operations gap without requiring the droplet to be associated with an activated electrode. This requirement reduces the required duration of electrode activation and prolongs the life of the droplet actuator.

The invention also provides a droplet actuator in which one or both gap-facing droplet operations surfaces is formed using a removable film. The removable film may, in various embodiments, also include other components ordinarily associated with the droplet actuator substrate, such as the dielectric layer and the electrodes. Further, the removable/replacement film may be pre-patterned, e.g., using an embossing technique, to provide topographical patterns such as those described herein.

Further, the invention provides droplet actuator devices and methods for coupling and/or sealing substrates of a droplet actuator, such as techniques for self-aligning assembly of droplet actuator substrates. The invention provides droplet actuators and methods of disassembling the droplet actuator in order to provide access for cleaning and/or recycling of droplet actuator surfaces.

### 6.1 Patterned Topographic Features

The invention provides patterned topographic features, which may be formed using a variety of available techniques. In one aspect, the invention provides methods of embossing the surfaces droplet actuators to produce the patterned topographic features. The patterned topographic features may include impressions in the droplet operations surface, such as depressed and/or elevated features, on the surface of at least one substrate of a droplet actuator. For example, depressed paths formed on the dielectric layer of the substrate may be used to guide droplets during droplet operations and/or to serve as fluid reservoirs. Where the droplet actuator includes top and bottom substrates, the gap-facing substrates of one or both surfaces may include patterned topographic features.

In one embodiment of the invention, adhesive-backed polymer films may be used as the dielectric layer in which the desired impressions are made. The adhesive portion of the dielectric/adhesive layer may be made to flow by application of pressure and/or temperature. As a result, a pattern may be embossed (e.g., heat-embossed) on the dielectric/adhesive layer. Using an embossing process, depressions may be formed that have a certain depth that is less than the adhesive thickness. For example, the depth of the depressions in some embodiments may be up to about 25 microns. Each depression forms a low pressure region which may be used to facilitate droplet operations and/or to assist in retaining one or more droplets in position. Additionally, the geometry of the depressions may assist in sizing and/or shaping droplets.

In another aspect of the invention, the droplet operations surface may be removable and/or replaceable. For example, the surfaces may include materials that may be removed and replaced by new materials. As an example, the droplet operations surface may include a film affixed to a substrate using an adhesive that permits the film to be removed from the surface and replaced with a replacement film. In this embodiment, the droplet operations surface may or may not have patterned three-dimensional (3D) features.

### 6.1.1 Embossing a Droplet Operations Surface

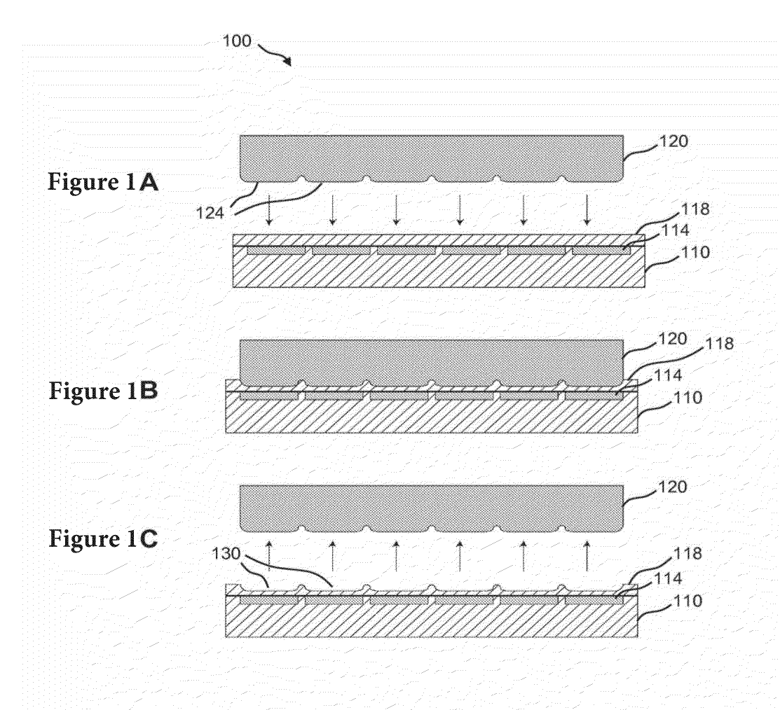

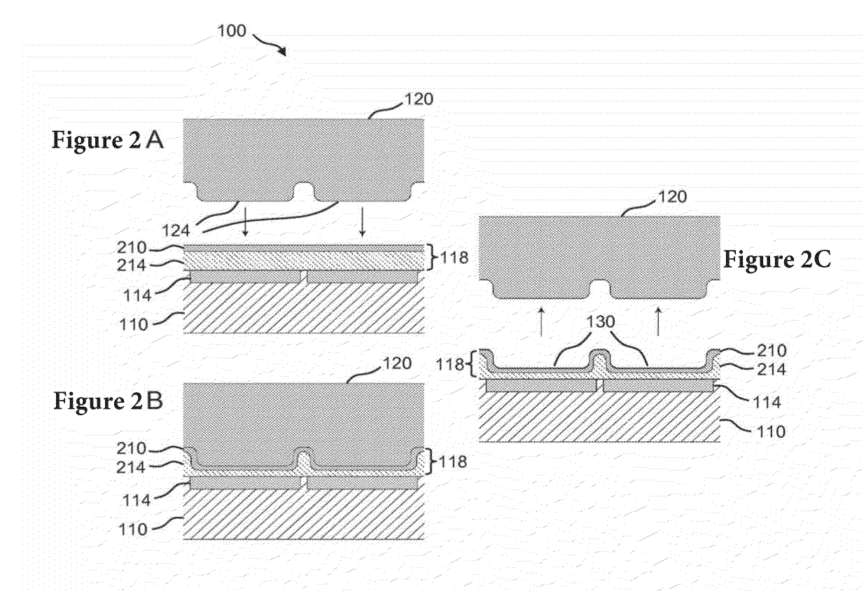

FIGS. 1A-1C illustrate side views of a process 100 of embossing a pattern into the substrate of a droplet actuator. Process 100 may be considered a non-limiting example of an embossing process used to create 3D impressions in the dielectric/adhesive layer of a substrate of a droplet actuator. FIGS. 1A-1C show a substrate 110, which may be, for example, a substrate that is suitable for use in a droplet actuator. The substrate may in some embodiments be a substantially non-conducting substrate. Examples of suitable substrates include silicon substrates, polymer substrates, plastic substrates, printed circuit board (PCB) substrates, and substrates including a combination of any of the foregoing. An arrangement of droplet operations electrodes 114 (e.g., electrowetting electrodes) is associated with substrate 110. A dielectric/adhesive layer 118 is provided atop droplet operations electrodes 114. The adhesive portion of dielectric/adhesive layer 118 is formed of an adhesive material that will flow under heat and pressure. More details of dielectric/adhesive layer 118 are described with reference to FIGS. 2A-2C.

FIGS. 1A-1C also show a mold 120 that has a set of 3D features 124 patterned on a surface thereof according to a desired topology. The 3D features 124 may, for example, correspond to a certain arrangement of droplet operations electrodes 114 upon substrate 110. Preferably, mold 120 is formed of a material, such as nickel, silicon or stainless steel, that provides good dimension stability under heat and pressure and can be precisely machined or fabricated. Optionally, the surface of mold 120 may be coated with a releasing agent (not shown) to assist in separating mode 120 from substrate 110. Examples of releasing agents may include, but are not limited to, hydrophobic coatings, such as TEFLON® coatings, CYTOP® coatings, silane coatings, and silicone coatings. In some embodiments, the mold may be a flat mold. In other embodiments, the mold may be a roller mold.

FIG. 1A shows a first step of process 100 of embossing a pattern into the substrate of a droplet actuator. In this step, mold 120 that has 3D features 124 patterned thereon is aligned with substrate 110. Mold 120 is then brought into contact with dielectric/adhesive layer 118 of substrate 110.

FIG. 1B shows a second step in which mold 120 is in contact with dielectric/adhesive layer 118 of substrate 110, and a certain amount of heat and/or pressure are applied to the assembly for an amount of time that is suitable to cause the adhesive portion of dielectric/adhesive layer 118 to flow. In this way, a reverse impression of 3D features 124 of mold 120 is formed in dielectric/adhesive layer 118 of substrate 110. The amount of heat, pressure, and time may be dependent on the type of adhesive material of dielectric/adhesive layer 118.

FIG. 1C shows a third step in which mold 120 is separated from dielectric/adhesive layer 118 of substrate 110, leaving a 3D impression within, dielectric/adhesive layer 118 that corresponds to 3D features 124 of mold 120. In this example, the pattern that is left within dielectric/adhesive layer 118 is a set of depressions 130 whose positions substantially correspond to the positions of droplet operations electrodes 114. Depressions 130 may be any application-specific depth and geometry.

In some embodiments the mold may serve a dual purpose of embossing and transferring a coating material onto the dielectric's surface (not shown in the figure). The coating may be uniform across the mold or may be a patterned coating that is hydrophobic in some areas and hydrophilic in other areas. The coating may be a single layer coating or may comprise of multiple layers of different coating materials. The coating should preferably adhere to the dielectric surface than the mold under the embossing conditions. The dielectric surface may be treated, for example using an oxygen plasma, to increase the affinity of the coating to its surface in comparison to the mold. Examples of hydrophobic coatings include TEFLON®, CYTOP®, organosilane, fluorosilane or a silicone. Examples of hydrophilic coatings include polymers such as polyethylene oxide or polyethylene glycols. In certain embodiments the coating is a conductive coating such as conductive polymer. The conductive coating may serve as a reference electrode for performing droplet operations.

In some embodiments, following use of the droplet actuator, the dielectric portion of the dielectric/adhesive layer 118 may be removed and replaced by a new dielectric. Some or all of the adhesive may also be removed and replaced as needed in order to provide a refurbished droplet operations surface.

FIGS. 2A-2C illustrate side views that show more details of process 100 of embossing a pattern into the substrate of a droplet actuator. FIGS. 2A, 2B, and 2C show that dielectric/adhesive layer 118 that is atop droplet operations electrodes 114 of substrate 110 may be formed of a dielectric layer 210 that is bonded to substrate 110 via an adhesive layer 214. Dielectric layer 210 is formed of a dielectric material that remains substantially dimensionally stable under heat and pressure. That is to say that the thickness of dielectric layer 210 remains substantially constant under heat and pressure that is causing its topology to vary. In one example, dielectric layer 210 may be formed of a polymer film, such as a polyimide dielectric layer. Adhesive layer 214 is formed of an adhesive material, such as acrylic materials that will flow under heat and pressure. In one example, adhesive layer 214 may be formed of the Pyralux family of materials, such as DuPont PYRALUX® flexible bonding film, which flows at about 200° C. In an alternative embodiment, instead of the combination of dielectric layer 210 and adhesive layer 214, dielectric/adhesive layer 118 may be formed of one material that may serve as both the dielectric and adhesive and that can flow under heat and pressure.

FIG. 2A again shows the first step of process 100 of embossing a pattern into the substrate of a droplet actuator. In this step, mold 120 that has 3D features 124 patterned thereon is aligned with substrate 110. Mold 120 is then brought into contact with dielectric layer 210 and adhesive layer 214 of substrate 110.

FIG. 2B again shows mold 120 in contact with dielectric layer 210 and adhesive layer 214 of substrate 110, and a certain amount of heat and/or pressure are applied to the assembly for an amount of time that is suitable to cause adhesive layer 214 to flow. The flow of adhesive layer 214 conforms the topology of dielectric layer 210 according to the pattern of mold 120. The thickness of dielectric layer 210 remains substantially constant and the continuity of dielectric layer 210 remains unbroken even though the topology is varying. In this way, a reverse impression of 3D features 124 of mold 120 is formed in dielectric layer 210 and adhesive layer 214 of substrate 110.

FIG. 2C again shows mold 120 separated from dielectric layer 210 and adhesive layer 214 of substrate 110, leaving a 3D impression within dielectric layer 210 and adhesive layer 214 that corresponds to 3D features 124 of mold 120. Again, in this example, the pattern that is left within dielectric layer 210 and adhesive layer 214 is a set of depressions 130 substantially corresponding to the positions of droplet operations electrodes 114. Depressions 130 may be any application-specific depth and geometry. In the illustrated embodiment, the depth of depressions 130 as illustrated is slightly less than the original thickness of adhesive layer 214 to ensure a suitable coating of adhesive layer 214 over the surface area of substrate 110.

In some embodiments, following use of the droplet actuator, dielectric layer 210 may be removed and replaced by a new dielectric layer. Some or all of adhesive layer 214 may also be removed in the process of removing dielectric layer 210. The removed adhesive layer 214 may also be replaced as needed in order to provide a refurbished droplet operations surface. The surface may be re-embossed as needed. In some embodiments, the dielectric layer is patterned to a desired topology before it is mounted on substrate 110, e.g., using an embossing process similar to the one described above.

### 6.1.2 Topographically Patterned Droplet Operations Surface

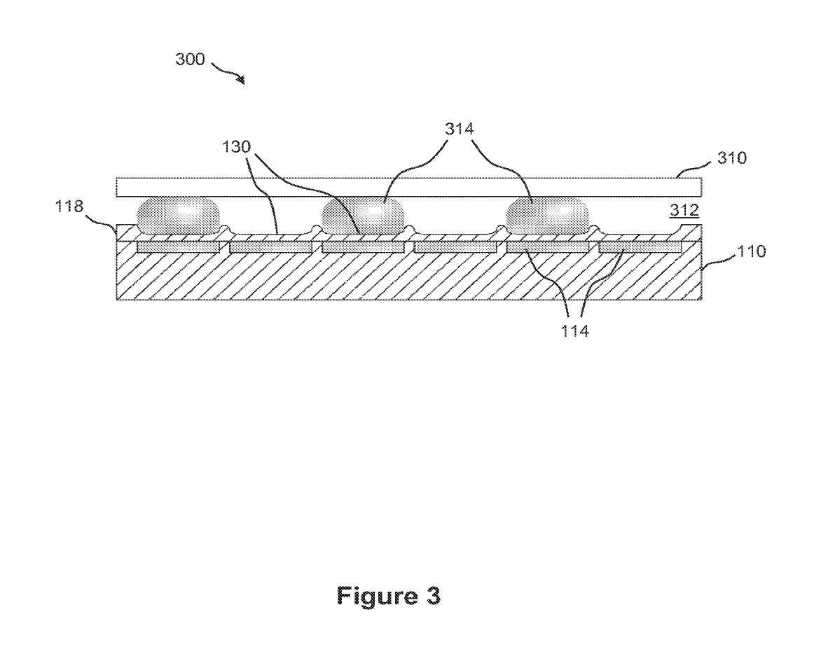

FIG. 3 illustrates a side view of a section of a droplet actuator 300 that has been patterned via the embossing process, such as process 100, of the invention. In this example, droplet actuator 300 may include substrate 110 that has been patterned as illustrated by FIGS. 1A-2C. Substrate 110, which has droplet operations electrodes 114, provides the bottom substrate of droplet actuator 300. Droplet actuator 300 further includes a top substrate 310. Substrate 110, which is the bottom substrate, and top substrate 310 are separated by a droplet operations gap 312. The height of droplet operations gap 312 may be any height which is suitable for one or more droplet operations to be conducted therein. Depressions 130, which may be formed by process 100 of the invention, are positioned to substantially correspond with the positions of droplet operations electrodes 114 of droplet actuator 300. One or more droplets 314 are shown at one or more droplet operations electrodes 114 and resting within the corresponding depressions 130. During droplet operations, depressions 130 are useful for, among other things, guiding, sizing, and/or shaping droplets 314. Further, depressions 130 may be used to assist in holding droplets 314 in a certain location, even when droplet operations electrodes 114 are turned off. In one embodiment of the invention, electrical fields from activated electrodes are used to move droplets. Once a droplet is in place, the activated electrode may be deactivated, and the droplet may be retained in place by the physical features of the bottom substrate.

Following a use of droplet actuator 300, which may contaminate the droplet operations surface, the dielectric layer may be removed and replaced by a new dielectric layer. Some or all of the adhesive layer may also be removed in the process of removing the dielectric layer. The removed adhesive layer 214 may also be replaced as needed in order to provide a refurbished droplet operations surface. The surface may be re-embossed as needed, or the replaced layer may be pre-patterned before being applied to the droplet actuator substrate. The surface of the top substrate 310 that faces the droplet operations gap may also be cleaned and/or refurbished. Alternatively, top substrate 310 may be replaced with a new top substrate. Top substrate 310 may be removed as needed for refurbishment of the droplet operations surface of the bottom substrate.

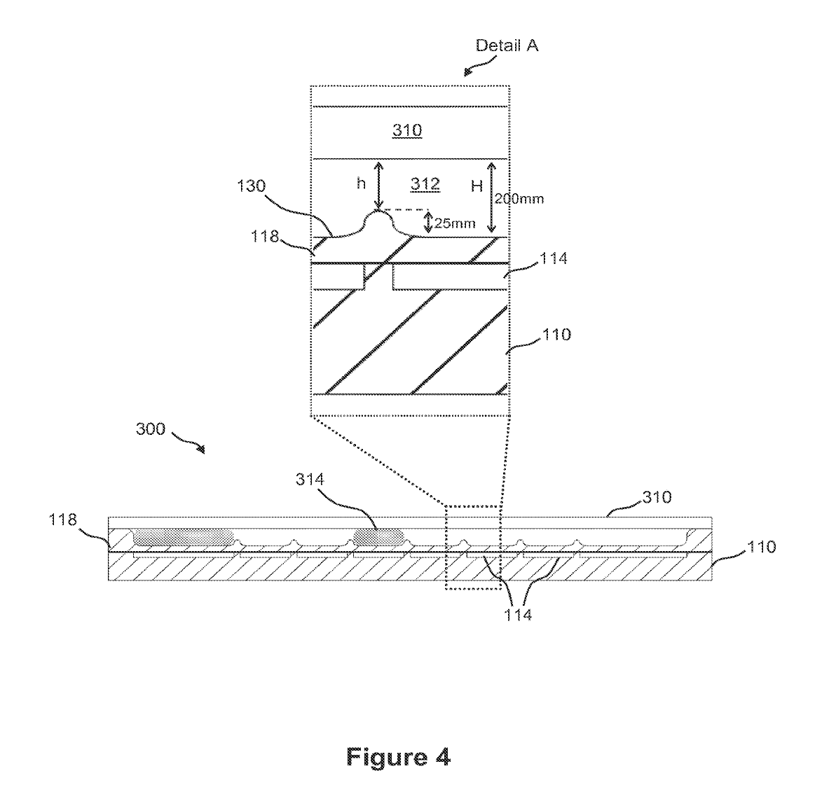

FIG. 4 illustrates a side view that shows more details of droplet actuator 300 of FIG. 3 that has been patterned via the embossing process, such as process 100, of the invention. Detail A of FIG. 4 shows more features of droplet actuator 300 having certain exemplary but non-limiting features with respect to depressions 130, which are embossed into dielectric/adhesive layer 118. In this example, the depth of each depression 130 may be about 25 microns, the height H from top substrate 310 to the bottom of each depression 130 may be about 200 microns, leaving a height h from top substrate 310 to the upper edge of each depression 130 of about 175 microns.

There is a pressure difference in droplet operations gap 312 of droplet actuator 300 between the area (having the height H) that is inside of each depression 130 and the area (having the height h) that is outside of each depression 130. This pressure is inversely proportional to the height. Therefore, because height H is greater than height h, the pressure inside of each depression 130 is lower than the pressure outside of each depression 130. Consequently, droplets 314 will tend to flow into each depression 130. The pressure equations are generally as follows.

ΔP1=γ(1/H); where ΔP1 is the pressure across height H, where γ is interfacial tension.

ΔP2=γ(1/h); where ΔP2 is the pressure across height h, where γ is interfacial tension.

Because height H is greater than height h, ΔP1 is less than ΔP2. Therefore, liquid tends to flow from the area of height h to the area of height H.

In various embodiments, a droplet actuator of the invention is provided in which H and h are selected to cause a droplet to be retained in a depression within a substrate of the droplet actuator. The substrate may be the top and/or bottom substrate.

In some cases, embossed surfaces are provided atop electrodes, as illustrated in the foregoing figures. In other cases, the pressure differences described above may be used to deposit a droplet in a region of a droplet actuator without requiring an electrode. In still other cases, an electrode is activated to cause the droplet to flow into a region of a droplet actuator. Once the droplet is in place, the activated electrode may be deactivated, and the droplet may be retained in place by the embossed physical structures of the droplet operations surface.

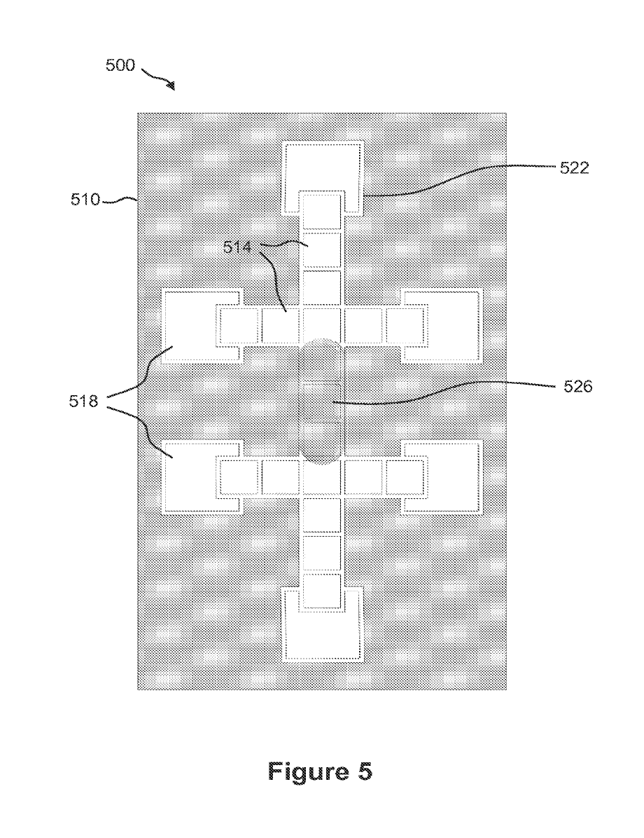

FIG. 5 illustrates a top view of another example of a droplet actuator 500 that has been patterned by an embossing process, such as process 100, of the invention. In this example, droplet actuator 500 includes a bottom substrate 510 and a top substrate (not shown). An arrangement of droplet operations electrodes 514 (e.g., electrowetting electrodes) provide paths between multiple reservoir electrodes 518. By use of a mold and the embossing process, such as process 100, of the invention, a depression 522 may be formed that substantially corresponds to the overall footprint of droplet operations electrodes 514 in combination with reservoir electrodes 518. That is, the boundary of depression 522 substantially follows the outer perimeter of the overall footprint of droplet operations electrodes 514 in combination with reservoir electrodes 518. During droplet operations within droplet actuator 500, the presence of depression 522 provides a channel along the arrangement of droplet operations electrodes 514 and reservoir electrodes 518. The channel may, for example, be suitable for controlling distribution of contaminants in a filler fluid, which surrounds droplets 526 in the channel.

### 6.1.3 Topographically Patterned Top Substrate

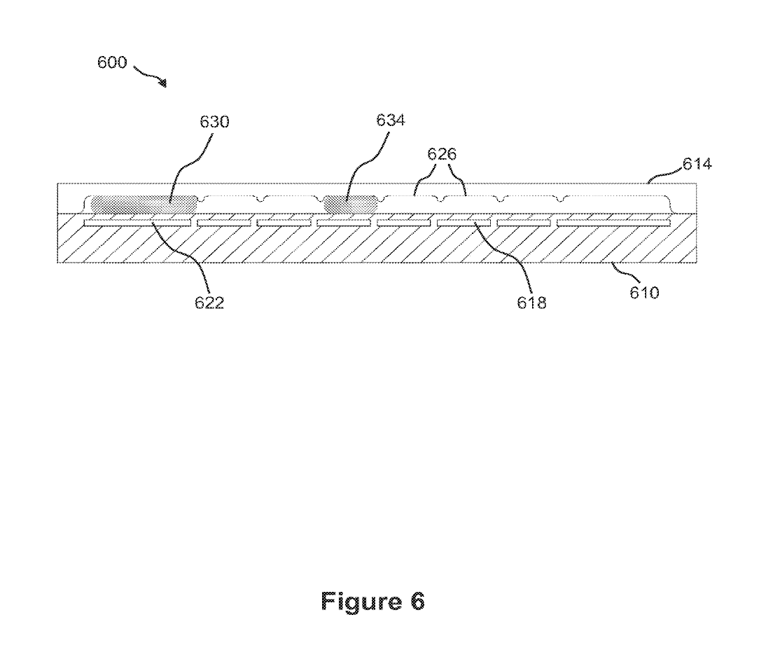

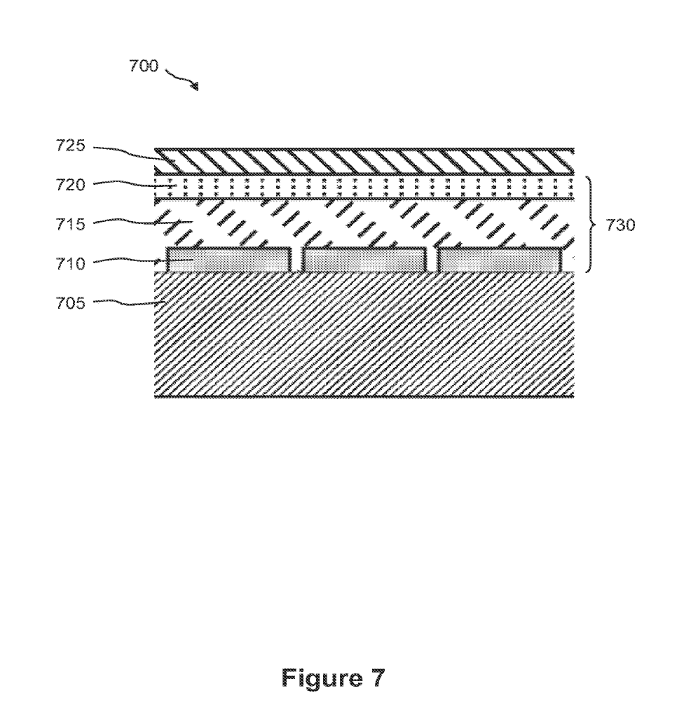

FIG. 6 illustrates a top view of yet another example of a droplet actuator 600 that has been patterned using an embossing process, such as process 100, of the invention or formed using other available techniques for forming plastics or the like. In this example, the top substrate of the droplet actuator is embossed instead of the bottom substrate. Droplet actuator 600 includes a bottom substrate 610 and a top substrate 614 that are separated by a gap. An arrangement of droplet operations electrodes 618 (e.g., electrowetting electrodes) and one or more reservoir electrodes 622 is provided on bottom substrate 610. Further, a set of depressions 626 are provided at the surface of top substrate 614, which substantially correspond to the positions of droplet operations electrodes 618 and reservoir electrodes 622. Depressions 626 in top substrate 614 may be formed by the embossing process, such as process 100, or other suitable processes. FIG. 6 shows a quantity of fluid 630 at a certain reservoir electrode 622. Droplets 634 may be dispensed via droplet operations from the quantity of fluid 630 at reservoir electrode 622. The top substrate may be coated or patterned with a material, such as ITO, for use as a reference electrode.

In one embodiment of the invention, electrical fields from activated electrodes are used to move droplets. Once a droplet is in place, the activated electrode may be deactivated, and the droplet may be retained in place by the physical features of the top substrate.

An aspect of the invention is that the presence of a depression at a reservoir electrode may serve to increase the capacity of the fluid reservoir. This is because the height H inside the fluid reservoir area serves to increase the capacity of the fluid reservoir. For example, when height H that is inside the fluid reservoir is about 2 times the height h that is outside of the fluid reservoir, the capacity is doubled.

In another embodiment, depressions may be provided in both the bottom and top substrates of the droplet actuator via the embossing process of the invention. The top and/or bottom substrate features may partially or completely mirror each other. Alternatively, certain regions of the droplet actuator may include the depressions on the top substrate, while other regions include the depressions in the bottom substrate. In one embodiment of the invention, electrical fields from activated electrodes are used to move droplets. Once a droplet is in place, the activated electrode may be deactivated, and the droplet may be retained in place by the physical features of the top and/or bottom substrate. Droplet operations electrodes and reference electrodes may be provided on either or both substrates. In some cases, reference electrodes are provided along ridges, while droplet operations electrodes are aligned with depressions.

### 6.2 Replaceable Surface Film

The invention provides a droplet actuator in which one or both gap-facing droplet operations surfaces is formed using a removable film. The removable film preferably includes a hydrophobic surface. The removable film may, in various embodiments, also include other components ordinarily associated with the droplet actuator substrate, such as the dielectric layer and the electrodes. Further, the film may be pre-patterned to provide topographical patterns such as those described above, e.g., using a roller mold or a flat mold.

The removable film may be held in place by an adhesive, by tension, by vacuum, by pressure, and/or by other means. In one example, the removable film includes an adhesive backing which is suitable for binding the removable film to the substrate. In another example, openings are provided in the substrate, and the film is held in place by a vacuum pressure applied through the openings. For example, vias in the electrodes may be used to suck the film onto the surface. The vacuum may be applied during operation and removed to release the film and facilitate replacement of the film. An adhesive may or may not be used in various aspects of this embodiment.

In another example, the removable film extends across the droplet actuator substrate and is held in place by tension. In this example, the removable film may be anchored outside the droplet actuator, and the droplet actuator substrate may be pressed into the sheet and/or the sheet may be pulled against the droplet actuator, to create a tension which holds the film in place against the droplet actuator substrate. The tension may be maintained while conducting droplet operations. When the surface of the film becomes fouled, the film may be replaced. In certain aspects of this embodiment, a mildly binding adhesive may be used or no adhesive at all may be used. In some cases, the tension may be released to facilitate replacement of the film. In other aspects, a lubricant may be used to cause the film to slide across the surface of the droplet actuator substrate without requiring the tension to be released. In one embodiment, a reel-to-reel configuration may be provided to supply a fresh film as needed on the droplet actuator. A lubricant may be applied to the film as it rolls off of the supply roll to facilitate sliding of the film across the droplet actuator surface.

In one embodiment, the film may be backed by an adhesive which binds the film to the droplet actuator surface. In some cases, the adhesive reversibly binds the film to the droplet actuator surface.

In one embodiment, the film comprises a dielectric material, such as a polyimide film. In some cases, the dielectric material is coated with a hydrophobic coating. In some cases, the dielectric material is backed by an adhesive, such as a polyimide film backed by an acrylic adhesive. In some cases, the adhesive-backed dielectric material may serve as the only dielectric for the droplet actuator substrate. In another embodiment, the adhesive-backed dielectric material may be provided atop another dielectric, which is provided atop the electrodes. In this case, the adhesive-backed dielectric material may supplement the second dielectric. The adhesive itself may, in some embodiments, serve as a dielectric.

FIG. 7 illustrates a droplet actuator substrate 700 that includes a substrate 705, electrodes 710 associated with substrate 705, an adhesive layer 715 atop electrodes 710, a dielectric layer 720 atop adhesive layer 715, and hydrophilic coating 725 atop dielectric layer 720. Substrate 705 may be any rigid substrate, such as a silicon substrate, a PCB substrate, a plastic substrate, or other polymeric substrate. Electrodes 710 may be any material which is suitably conductive to permit electrodes 710 to mediate droplet operations atop droplet actuator substrate 700. Examples include copper, chrome, aluminum, gold, silver, and other conductive materials. Adhesive layer 715 may be any adhesive which is suitable for binding dielectric layer 720 to the underlying layers of the droplet actuator. In alternative embodiments, adhesive layer 720 may be absent or may be replaced with a lubricant.

In the embodiment illustrated, adhesive layer 715 binds dielectric layer 720 to electrodes 710 and to substrate 705. Dielectric layer 720 may be any dielectric material. Hydrophobic coating 725 may be any hydrophobic coating that binds to the underlying layers in a manner which is sufficient to permit one or more droplet operations to be conducted atop droplet actuator substrate 700. In one example, dielectric layer 720 is a polyimide film. In yet another example, adhesive layer 715 includes an acrylic adhesive. In still another example, an adhesive-backed polyimide film 730 provides adhesive layer 715 and dielectric layer 720. For example, adhesive-backed polyimide film 730 may be a PYRALUX® LF flexible composite (DuPont). PYRALUX® LF7013, for example, is an approximately 13 microns thick Dupont KAPTON® polyimide film and 25 microns thick acrylic adhesive. Other examples of suitable adhesive-backed films include PYRALUX® LF LF0110, LF0120, LF0130, LF0150, LF0210, LF0220, LF0230, LF0250, LF0310, LF7001, LF7082, LF1510, and LF7034.

The adhesive-backed polyimide film 730 may be coated with a hydrophobic layer. Examples of suitable hydrophobic coatings include fluoropolymers and perfluoroploymers, such as polytetrafluoroethylenes; perfluoroalkoxy polymer resins; fluorinated ethylene-propylenes; polyethylenetetrafluoroethylenes; polyvinylfluorides; polyethylenechlorotrifluoroethylenes; polyvinylidene fluorides; polychlorotrifluoroethylenes; and perfluoropolyethers. In one embodiment, the hydrophobic, coating includes a TEFLON® fluoropolymer. In another embodiment, the hydrophobic coating includes a CYTOP™ perfluoropolymer.

In some embodiments, the adhesive is selected to be releasable, so that the adhesive-backed film may be removed following use and replaced with a fresh adhesive-backed film. In some embodiments, the adhesive may serve as the dielectric and the backing may serve as a hydrophobic coating. In other embodiments, the dielectric may be permanent and a film having a hydrophilic backing may be applied to the permanent dielectric. In yet another embodiment, multiple films may be used and replaced together or separately. For example, a hydrophobic film may be used atop a dielectric film, and both films may be applied atop a droplet actuator substrate including electrodes. Each of the hydrophobic film and dielectric film may be replaced together or separately, as needed. A lubricant may be applied between the hydrophobic film and dielectric film and/or between the dielectric film and the substrate. In some cases, the lubricant may also serve as a dielectric.

In one embodiment, the film includes a dielectric film, and the droplet actuator substrate includes the substrate, electrodes and a dielectric atop the substrate. The film is placed atop the dielectric, and a lubricant or an adhesive may optionally be included between the dielectric and the film.

In another embodiment, the film includes a dielectric film, and the droplet actuator substrate includes the substrate, electrodes and a dielectric atop the substrate. The film may be placed atop the dielectric, and a lubricant or an adhesive may optionally be included between the dielectric and the film. Alternatively, the droplet actuator substrate may include the substrate and electrodes with no dielectric atop the substrate. The film may be placed atop the substrate and electrodes, and a lubricant or an adhesive may optionally be included between the substrate and electrodes and the film.

Replacement of the film may be automated. For example, a diagnostic may be executed to determine the extent of contamination of the film. When contamination reaches a predetermined threshold, the film may be replaced. Alternatively, for certain applications, the film may simply be replaced after each use of the droplet actuator to avoid the possibility of contamination from one batch to another.

In some embodiments, the filler fluid (when used) may also be replaced as needed. For example, the filler fluid may be replaced when the film is replaced. In another example, the filler fluid may be replaced more or less frequently than the film.

### 6.3 Coupling Top and Bottom Substrate

The invention provides droplet actuator devices and methods for coupling and/or sealing the top and bottom substrates of a droplet actuator. In various embodiments, the invention provides droplet actuators and methods for self-aligning assembly of droplet actuator substrates, such that the top and bottom substrate may be quickly and easily assembled and sealed. In various embodiments, the invention provides droplet actuators and methods of readily disassembling the droplet actuator in order to provide access for cleaning and/or recycling of components (e.g., bottom substrate, top substrate).

6.3.1 Soldering Attachment

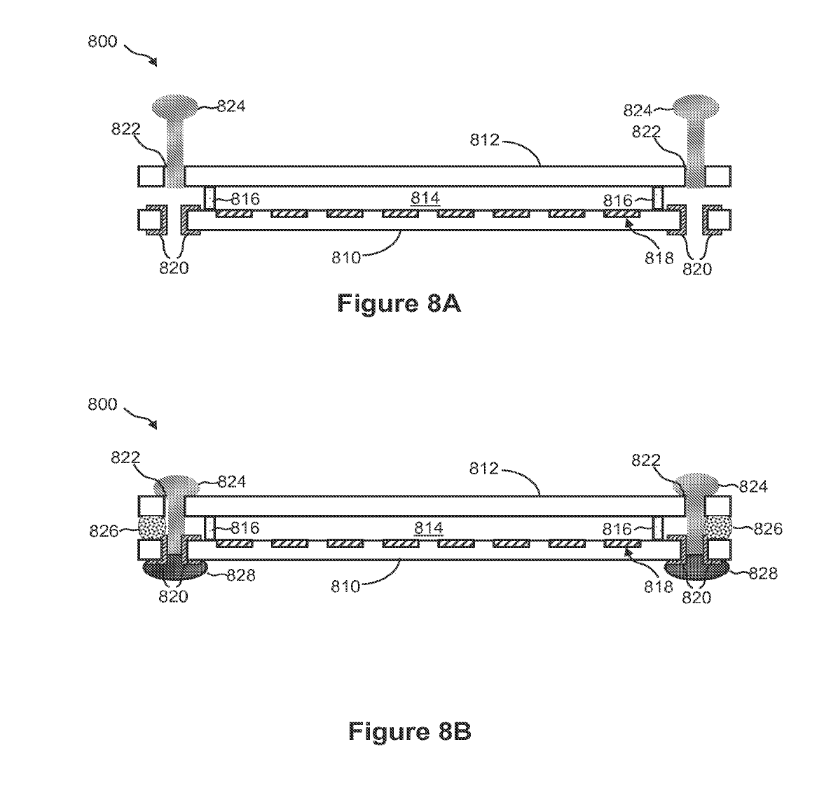

FIGS. 8A and 8B illustrate side views of a section of a droplet actuator 800 as well as a method of attaching the top and bottom substrates by soldering. This embodiment illustrates the use of fasteners and soldering to couple a bottom substrate to a top substrate and a gasket to seal the droplet actuator.

As shown in FIG. 8A, droplet actuator 800 may include a bottom substrate 810. Bottom substrate 810 may be separated from a top substrate 812 by a gap 814. One or more spacers 816 may be used to establish the size of gap 814, i.e., the distance between the top substrate 812 and the bottom substrate 810. Spacers 816 may, for example, be formed of a rigid material, such as a solder mask material, glass beads, and/or other spacer materials.

Bottom substrate 810 may include an arrangement of droplet operations electrodes 818 (e.g., electrowetting electrodes). Bottom substrate 810 may, for example, be formed of a PCB that includes plated vias 820. Top substrate 812 may, for example, be formed of silicon based materials, glass, plastic or another suitable substrate (that does not include material suitable for soldering). Top substrate 812 may also include electrodes, such as one or more ground electrodes (not shown). One or more openings 822 are provided within top substrate 812. Each opening 822 is substantially aligned with a respective placed via 820 of bottom substrate 810. Each opening 822 is of sufficient size to accommodate a fastener 824. Each fastener 824 may, for example, be a copper rivet.

FIG. 8B shows assembled droplet actuator 800. Spacers 816 determine the size of gap 814. Gasket 826, such as an o-ring, may be used to provide a seal around the outer edge of droplet actuator 800. Bottom substrate 810 may be coupled to top substrate 812 by inserting fasteners 824 through openings 822 and into plated vias 820. Solder seal 828 may be used to secure each fastener 824 in its respective plated via 820.

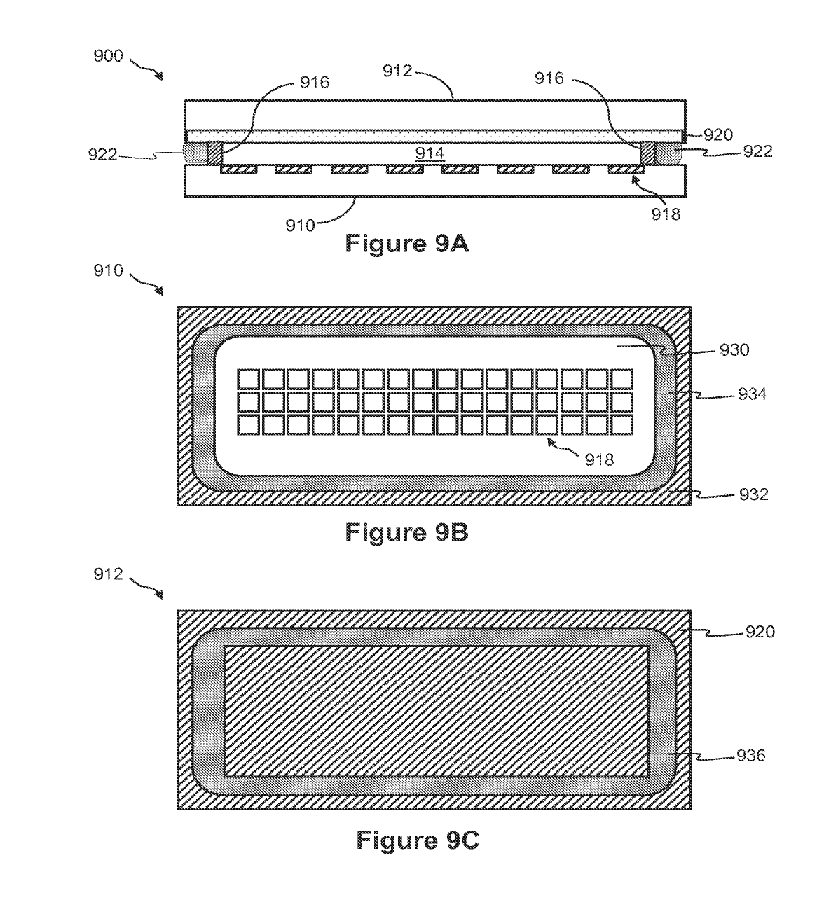

FIGS. 9A-9C illustrate views of a droplet actuator 900 and another method for using soldering to couple top and bottom substrates and, optionally, to seal the droplet operations gap. The bottom substrate and the top substrate include material that is suitable for soldering in order to provide attachment and to seal the droplet actuator.

FIG. 9A illustrates a side view of droplet actuator 900. Droplet actuator 900 may include a bottom substrate 910. Bottom substrate 910 may be separated from a top substrate 912 by a droplet operations gap 914. One or more spacers 916 may be used to establish the size of gap 914. Spacers 916 may, for example, be formed of a flexible or rigid spacer material, such as a solder mask material, glass bead, and/or other spacer materials.

Bottom substrate 910 may include an arrangement of droplet operations electrodes 918 (e.g., electrowetting electrodes). Bottom substrate 910 may, for example, be formed of a PCB. Top substrate 912 may, for example, be formed of a PCB that includes a copper layer 920. Copper layer 920 provides material that is suitable for soldering and may also function as an electrical ground. Copper layer 920 may also be patterned such that no hydrophobic material is present in the area at which a seal is to be formed. Bottom substrate 910 may be coupled to top substrate 912 by a solder ring 922. Solder ring 922 may also seal droplet actuator 900 such that fluids within droplet actuator 900 are retained.

FIG. 9B illustrates a top view of bottom substrate 910 of droplet actuator 900. Bottom substrate 910 may be patterned to include a layer 930 that includes an arrangement of droplet operations electrodes 918 configured for conducting droplet operations in droplet operations gap 914. Bottom substrate 930 may also include a layer 932 that is a layer of exposed copper such that layer 932 is devoid of dielectric and hydrophobic coatings. In an alternative example, layer 932 may be a copper layer that has a gold or silver finish. Bottom substrate 910 may also include a layer 934 to which solder ring 922 is aligned.

FIG. 9C illustrates a top view of top substrate 912 of droplet actuator 900. Top substrate 912 may include a copper layer 920 that is patterned to provide a region 936 to which solder ring 922 is aligned. The patterning of top substrate 912 is such that layer 936 aligns with layer 934 of bottom substrate 910 and provides an area that is suitable for soldering.

In another embodiment, an area that is suitable for soldering (i.e., devoid of hydrophobic materials) may be formed by use of masking, prior to coating the top and bottom substrates with hydrophobic materials. For example, latex body paint may be used to mask the substrate components. The latex paint may be applied using a foam applicator and allowed to air dry. A hydrophobic coating may then be applied and the latex paint removed to provide an area that is suitable for soldering.

### 6.3.2 Flexible Fasteners

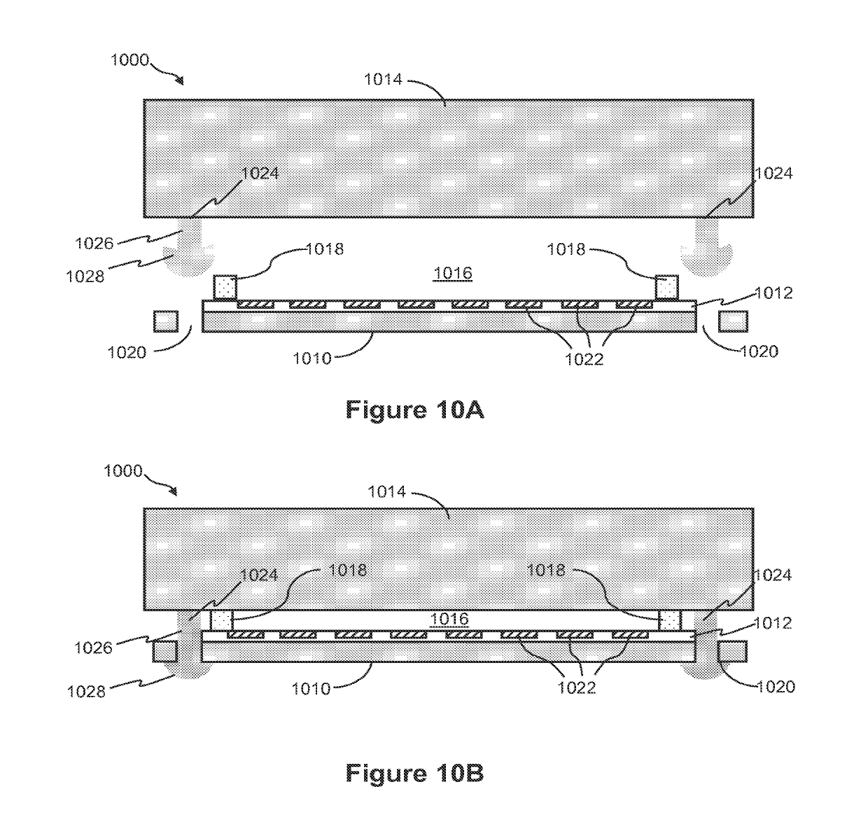

FIGS. 10A and 10B illustrate side views of a portion of a droplet actuator 1000 and a method for using flexible fasteners to couple the top and bottom substrates. This embodiment illustrates the use of flexible fasteners (i.e., deformable fasteners) to couple a bottom substrate to a top substrate and to a spacer, such as a gasket, to seal the droplet actuator. In one embodiment, the flexible fasteners are configured so that the top and bottom substrates may be coupled with sufficient pressure to provide a seal. The seal is sufficient for droplet actuator operation while permitting the top and bottom substrates to be quickly detached for cleaning and/or refurbishment.

As shown in FIG. 10A, droplet actuator 1000 may include a bottom plate 1010 that supports a bottom substrate 1012. Bottom substrate 1012 may, for example, be a PCB. Bottom plate 1010 may, for example, be formed of a plastic material or other suitable materials. Bottom plate 1010 may include one or more openings 1020. The arrangement of bottom plate 1010 and bottom substrate 1012 is such that bottom substrate 1012 is positioned within boundaries that are defined by openings 1020.

Bottom substrate 1012 may be separated from top substrate 1014 by a gap 1016. One or more spacers 1018 may be used to set the size of gap 1016. Spacers 1018 may, for example, be formed of an o-ring or other suitable spacer materials that provides a sufficient gap size and a sufficient seal. Bottom substrate 1012 may include an arrangement of droplet operations electrodes 1022 (e.g., electrowetting electrodes) configured to conduct droplet operations.

Top substrate 1014 may, for example, be formed of a plastic material or a plastic material that supports a glass top plate (not shown). One or more fasteners 1024 may be provided on top substrate 1014 such that each fastener 1024 is aligned with a respective opening 1020 on bottom plate 1010. Each fastener 1024 and opening 1020 provide for self-aligning of bottom plate 1010 and top substrate 1014. Each fastener 1024 may be a deformable fastener that includes a shaft 1026 and a flexible tab or deformable head 1028. Each opening 1020 is of sufficient size to accommodate shaft 1026 of fastener 1024.

FIG. 10B shows droplet actuator 1000 when assembled. Spacer 1018 is used to determine the size of gap 1016 and to seal droplet actuator 1000. Bottom plate 1010 and supported bottom substrate 1012 are coupled to top substrate 1014 by inserting fasteners 1024 through openings 1020. As each fastener 1024 is inserted through an opening 1020, tab 1028 is deformed to facilitate passage through opening 1020. Each fastener 1024 is positioned in an opening 1020 such that tab 1028 is on the outer edge of bottom plate 1010 and tab 1028 resumes its original shape upon full passage through opening 1020.

In another embodiment, threaded structures may be used to couple and seal a top substrate to a bottom substrate. For example, a top substrate and a bottom substrate may be circular or rectangular and include threaded structures that are circular or linear, respectively. The threaded structure provides secure attachment of a top substrate to a bottom substrate such that a leak-proof seal is formed.

The embodiments of the invention providing droplet actuator devices and methods for coupling and/or scaling the top and bottom substrates of a droplet actuator as described above with relation to FIGS. 8A-10B are only exemplary embodiments. It is contemplated that the top and bottom substrates may be coupled and/or sealed by clips, vices, elastomeric bands, fitting of the substrates into slots in a larger substrate, and the like.

### 6.4 Unit Cells

The present invention provides devices and methods for parallel processing of assays on a droplet actuator. The invention provides droplet actuators wherein droplet operations electrodes are organized into unit cells. The configuration of a unit cell may be optimized for a specific molecular assay or immunoassay such that all steps in an assay protocol may be performed within the unit cell. The configuration of the unit cell may be repeated any number of times (and/or in any combination) on the droplet actuator. The unit cells on a droplet actuator may be operated in parallel. The unit cells may also be configured to be electrically similar. The unit cell architecture provides for increased throughput in molecular assays or immunoassays (e.g., time to result). The unit cell architecture also provides dedicated lanes for each sample in a molecular assay or immunoassay and for each type of assay such that cross-contamination between samples is minimized, preferably entirely avoided.

In some embodiments all unit cells may not be configured to be functional. For example some unit cells may not have elements of a cartridge such as a top plate or a hydrophobic coating.

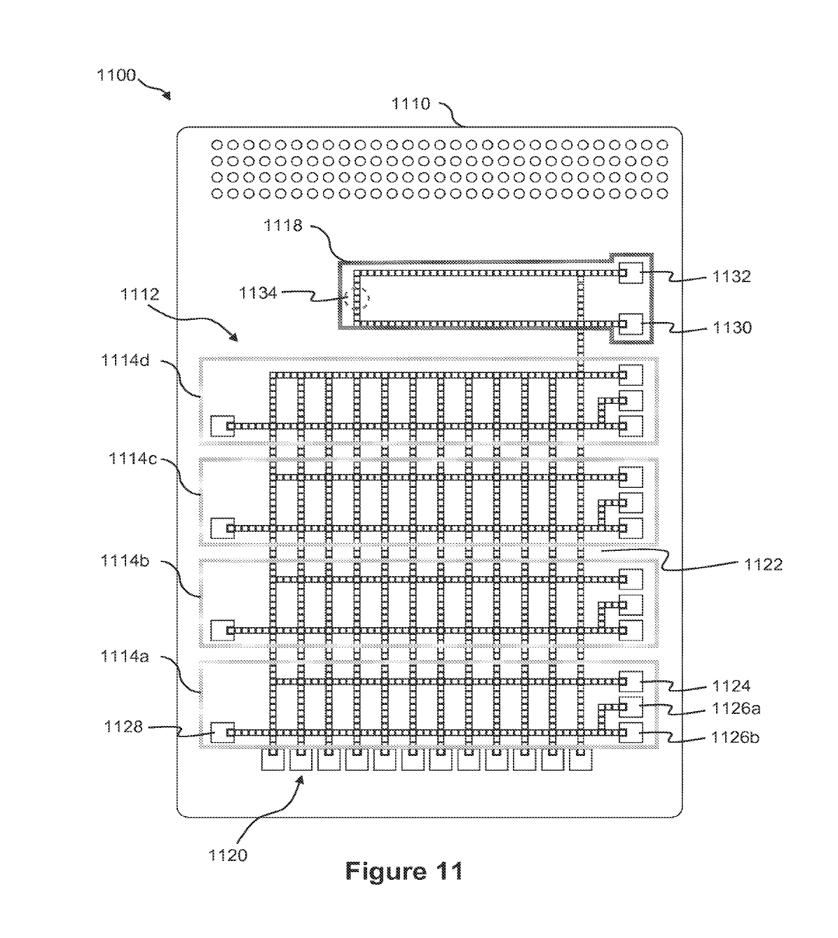

FIG. 11 illustrates a top view of a portion of a droplet actuator 1100 that has four unit cells and a separate detection cell. In this example, droplet actuator 1100 is configured to perform 48 molecular diagnostic assays or immunoassays in parallel. Droplet actuator 1100 may include a bottom substrate 1110. Bottom substrate 1110 may include an arrangement of droplet operations electrodes 1112 that are configured for droplet operations on a droplet operations surface thereof. In some cases, droplet actuator 1100 may also include a top substrate (not shown) that is arranged in a generally parallel fashion with bottom substrate 1110 and separated from bottom substrate to provide a droplet operations gap. In one example, droplet operations electrodes 1112 may be arranged to provide multiple unit cells 1114 (e.g., unit cells 1114a, 1114b, 1114c, and 1114d), and a detection cell 1118. Unit cells 1114 may, for example, be configured for conducting immunoassays such that each unit cell 1114 provides one type of immunoassay for multiple samples. Each unit cell can also be configured for enzymatic assays where one enzymatic assay is performed on each of the multiple samples. In a similar manner any liquid based protocol, where sample multiplexing (multiple tests on a single sample) needs to be performed, the unit cell design can be utilized to separate each assay into a specific zone on the droplet actuator with its own incubation times and other assay-specific requirements. A unit cell may include reagent reservoirs, including all reagents required to conduct a particular assay. A unit cell may include one or more sample reservoirs. A unit cell may be a single cartridge which can be assembled with other cartridges to form a much larger cartridge.

The architecture (i.e., configuration of droplet operations electrodes 1112) of droplet actuator 1100 is such that each unit cell 1114 may be connected to adjoining unit cells 1114 by electrode arrangements 1122, i.e., electrode arrangements 1122 may be used to transport droplets from one unit cell to the next. Unit cells 1114 also include sample reservoirs 1120 (e.g., 4 sample reservoirs 1120 in each unit cell). Detection cell 1118 may be connected to unit cells 1114 by electrode arrangement 1122. In alternative embodiments, one or more unit cells may include its own detection zone. In one embodiment, the detection modality is electrochemical, and the unit cell is fully self-contained, i.e., including all elements needed for dispensing sample and reagents, conducting an assay protocol, and detecting any signal produced as a result of the assay protocol.

In another embodiment, the detection modality is optical, and the unit cell is fully self-contained. In yet another embodiment, each unit cell includes a detection window, and the cartridge is moved to place each window into proximity with a common sensor for detection. Alternatively, the sensor may be moved to sequentially place each detection window into proximity with a common sensor for detection. In yet another embodiment, an array of sensors (such as a charge-coupled device (CCD) or photodiode array or an array of waveguides connected to photodetectors) perform simultaneous detection using a clear top or bottom substrate and/or using multiple detection windows.

In some cases, the reservoirs in different unit cells, such as wash reservoirs or reagent reservoirs, are coupled to common external liquid sources. A single wash fluid source, such as a well or reservoir formed in or associated with the top substrate, may supply multiple wash reservoirs within the droplet operations gap. As an example, a wash reservoir formed in a top substrate may be configured to overly multiple wash reservoirs in the droplet operations gap. The wash reservoir formed in the top substrate may include multiple openings, each opening providing a path from the top substrate wash reservoir into a droplet operations gap wash reservoir. In another embodiment, a single off-actuator wash reservoir may be coupled to a fluid path network, which supplies wash buffer into multiple on-actuator reservoirs.

In some cases, unit cells 1114 provide dedicated lanes for each sample or each type of assay such that any potential cross-contamination between samples is minimized, preferably entirely avoided. Unit cells 1114 may be operated in parallel such that assay throughput is sufficiently increased. In one embodiment, a droplet actuator is provided for multiple uses. During each use, one or more unit cells is used to conduct an assay protocol and then sealed, leaving unused unit cells for later use.

Detection cell 1118 may include a substrate reservoir 1130, a waste reservoir 1132, and a detection spot 1134. A single detection cell 1118 provides for serial detection of the end product of each of the 48 assays.

In the illustrated embodiment, all the steps of an assay (e.g., an immunoassay), except detection of an end product, are performed within each unit cell 1114. In one example, droplet actuator 1100 may be used to perform four different immunoassays (e.g., assay #1 in unit cell 1114a, assay #2 in unit cell 1114b, assay #3 in unit cell 1114c, and assay #4 in unit cell 1114d) on 12 samples from sample reservoirs 1120, for a total of 48 assays. Samples are loaded into sample reservoirs 1120 and then into unit cells 1114a through 1114d. Sample droplets are dispensed from sample reservoirs 1120 via droplet operations and transported using droplet operations along electrode arrangements 1122. A first reagent, such as a primary antibody, may be dispensed from reagent reservoir 1126a and incubated with the sample droplet. A waste supernatant droplet produced by a bead-washing protocol may be transported into waste reservoir 1128. A second reagent, such as a secondary antibody, may be dispensed from reagent reservoir 1126b and incubated with the sample droplet. A waste supernatant droplet produced by a bead-washing protocol may be transported into waste reservoir 1128. Wash buffer droplets are dispensed from wash reservoir 1124 and the beads may be washed a sufficient number of times using droplet operations to remove unbound material. Each sample (i.e., sample-antibody complex) may be then transported serially along electrode arrangements 1122 using droplet operations to detection cell 1118. A detection substrate may be dispensed from substrate reservoir 1130 and incubated with the sample-antibody complex to produce a signal. The sample-antibody complex may be then transported using droplet operations to detection spot 1134 for detection of the end product (e.g., chemiluminescent detection). The sample-antibody complex may be then discarded into waste reservoir 1132. Alternatively, the detection substrate may be processed in the presence of the sensor.

In another embodiment, detection cell 1118 may be connected to each of the unit cells 1114 by an electrode arrangement 1122 that is configured outside of unit cells 1114 such that the transportation of sample droplets across electrodes 1112 in adjacent unit cells 1114 is minimized.

In yet another embodiment, unit cells 1114 may be configured for different assays. For example, unit cell 1114a may be configured for PCR assay and unit cells 1114b through 1114d configured for immunoassays.

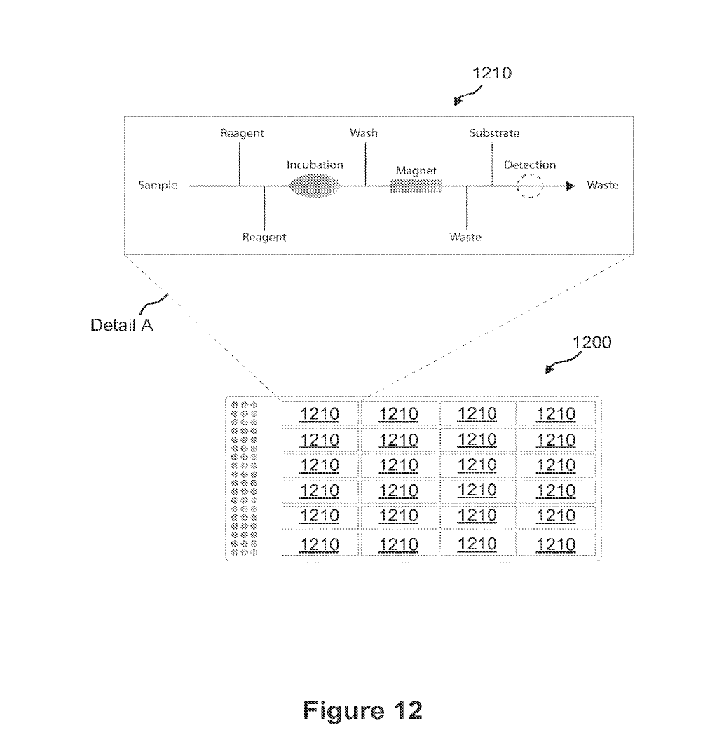

FIG. 12 is a diagram of a droplet actuator substrate 1200 that includes multiple unit cells 1210, where each unit cell 1210 includes its own detection region. A detail A of FIG. 12 shows a schematic view of each unit cell 1210. Unit cells 1210 of droplet actuator 1200 are similar to the unit cells of droplet actuator 1100 in FIG. 11 where each unit cells includes a sample reservoir, two reagent reservoirs, a wash reservoir, and a waste reservoir configured for performing an immunoassay (e.g., incubation region, wash region over a magnet). However, each un it cell 1210 of droplet actuator 1200 also includes the elements of the detection cell 1118 of droplet actuator 1100 in FIG. 11. In unit cells 1210, the detection cell, a substrate reservoir, a detection spot and a waste reservoir, may be arranged along a linear path with droplet operations electrodes that are configured for performing the immunoassay.

As illustrated in FIG. 12, droplet actuator 1200 includes 24 unit cells 1210 that are configured to perform 24 separate immunoassays in parallel. Because each unit cell 1210 includes its own detection spot, a movable detector (not shown) may be associated with droplet actuator 1200. The movable detector may be aligned with each unit cell 1210 for detection. Alternatively, the unit cells may be joined to a single detection spot by an electrode arrangement or other means for transporting a droplet into the presence of a detector.

In operation, a sample that includes magnetically responsive beads is loaded on and dispensed from a sample reservoir via droplet operations. A first reagent, e.g., a primary antibody, is dispensed from a reagent reservoir and incubated with the sample droplet (e.g., incubation region). A supernatant droplet is split off and dispensed into a waste reservoir. A second reagent, such as a secondary antibody, is dispensed from a second reagent reservoir and incubated with the sample droplet (e.g., incubation region). A waste supernatant droplet is dispensed into a waste reservoir. Wash buffer droplets are dispensed from a wash reservoir and the sample-antibody complex is washed over a magnet (not shown) using droplet operations a sufficient number of times to remove unbound material. A substrate droplet is dispensed from a substrate reservoir, mixed with the sample-antibody complex and transported to the detection spot. Following detection of antigen-antibody complexes, the sample-antibody complex is discarded in a waste reservoir.

In another embodiment, droplet actuator 1200 may be configured to provide 48 unit cells 1210 or any number of unit cells 1210. In yet another embodiment, all unit cells 1210 may be configured for conducting PCR assays. In yet another embodiment, unit cells 1210 may be configured for conducting pyrosequencing assays. For example unit cell 1210 may include 4 nucleotide input reservoirs (A, G, C, T), a wash reservoir, a reaction zone, a waste reservoir, and a detection zone arranged along a linear path. In yet another embodiment, unit cells 1210 may be configured for a combination of assays (e.g., immunoassays, PCR, pyrosequencing).

In yet another embodiment, a sample may be dispensed to two or more unit cells 1210 through a sample feed mechanism (e.g., path or array of droplet operations electrodes, not shown) to provide some degree of parallelism on droplet actuator 1200. Similarly, one or more reagents may be dispensed to two or more unit cells 1210 through a reagent feed mechanism, such as an arrangement of droplet operations electrodes (not shown).

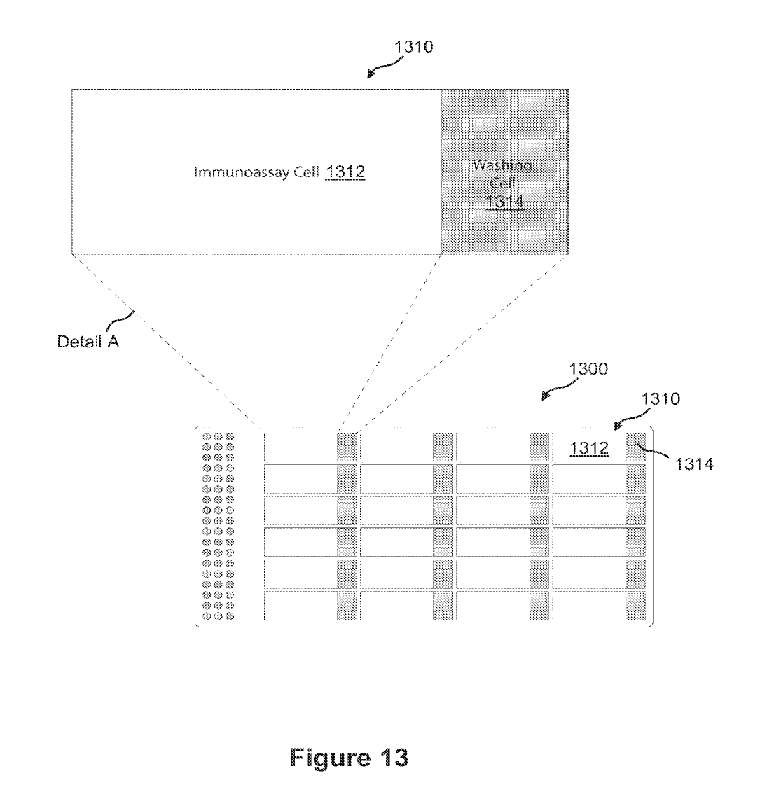

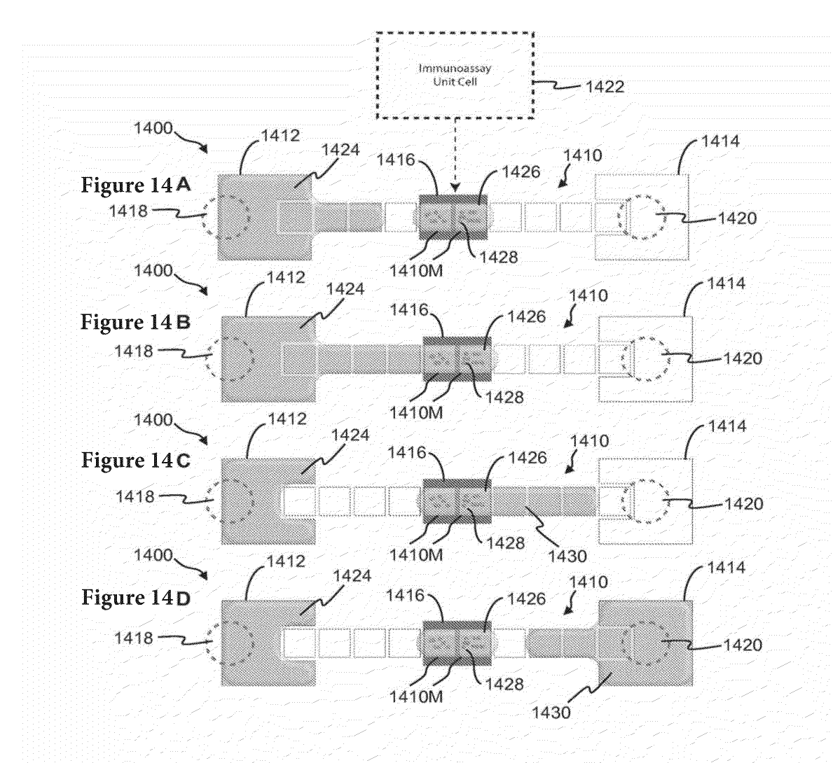

FIG. 13 is a top view of a portion of a droplet actuator 1300 that has multiple unit cells 1310, where each unit cell 1310 includes an immunoassay cell 1312 and a washing cell 1314 (or both the immunoassay cell and a washing cell may together constitute a single cell). A detail A of FIG. 13 shows more details of each unit cell 1310. Each immunoassay cell 1312 may be similar to the unit cells of droplet actuator 1200 of FIG. 12 that includes a sample reservoir, two reagent reservoirs, an incubation region, a substrate reservoir and a detection region. Each washing cell 1314 may include a wash reservoir, a wash region that includes a magnet, and a waste reservoir. Each washing cell 1314 is configured to minimize the number of droplet operations electrodes that are used to effectively wash a sample that includes magnetically responsive beads. Each immunoassay cell 1312 is connected to a respective washing cell 1314 via droplet operations electrodes. An example washing cell, in combination with an immunoassay cell is described in more detail in FIGS. 14A through 14D.

FIGS. 14A through 14D show a top view of a washing cell 1400 and a process of washing magnetically responsive beads in a washing cell. The method of the invention of FIGS. 14A through 14D is an example of a washing cell wherein a sample droplet that includes magnetically responsive beads is immobilized on a magnet and wash buffer fluid is flowed across the beads. The washing cell of the invention may be provided as one component of a complete unit cell that includes a washing cell and an immunoassay cell, such as described in FIG. 13.

Washing cell 1400 may include an arrangement of droplet operations electrodes 1410 (e.g., electrowetting electrodes) that are aligned with a wash reservoir electrode 1412 and a waste reservoir electrode 1414. A magnet 1416 is arranged in close proximity to droplet operations electrodes 1410. In particular, magnet 1416 is arranged such that certain droplet operations electrodes 1410 (e.g., two droplet operations electrodes 1410M) are within the magnetic field of magnet 1416. Magnet 1416 may, for example, be a permanent magnet or an electromagnet.

An opening 1418 in a top substrate (not shown) may be substantially aligned with or slightly overlapping wash reservoir electrode 1412. Opening 1418 is of sufficient size to dispense a number of droplets onto wash reservoir electrode 1412. Opening 1418 provides a fluid path for flowing fluid, such as wash buffer fluid, into washing cell 1400 and then onto wash reservoir electrode 1412. An opening 1420 in the top substrate (not shown) may be overlapping waste reservoir electrode 1414. Opening 1420 provides a fluid path for flowing fluid out of washing cell 1400.

Washing cell 1400 is arranged in proximity of an immunoassay cell 1422 such that a sample may be transported into and out of washing cell 1400. Immunoassay cell 1422 is configured for performing immunoassays.

Washing cell 1400 may include a wash buffer 1424 and a sample droplet 1426. Sample droplet 1426 may, for example, include a quantity of magnetically responsive beads 1428 that includes bound antigen and reporter antibody (i.e., antigen-antibody-reporter complex), and unbound material, such as excess unbound reporter antibody. Wash buffer 1424 is drawn from a wash buffer reservoir (not shown) through opening 1418 and onto reservoir electrode 1412 by activating reservoir electrode 1412.

FIG. 14A shows a first step in a process of washing magnetically responsive beads in a washing cell. In this step, sample droplet 1426 that has beads 1428 therein is positioned on droplet operations electrodes 1410M (which are active) within the magnetic field of magnet 1416. Because beads 1428 are magnetically responsive, beads 1428 are attracted to magnet 1416. Reservoir electrode 1412 and adjacent droplet operations electrodes 1410 are activated. A slug or finger of wash buffer 1424 is drawn away from reservoir electrode 1412 toward magnet 1416.

FIG. 14B shows another step in a process of washing magnetically responsive beads in a washing cell. In this step, the slug or finger of wash buffer 1424 is extended by activating droplet operations electrodes 1410 further along the path to magnet 1416, such that wash buffer 1424 is merged with sample droplet 1426.

FIG. 14C shows another step in a process of washing magnetically responsive beads in a washing cell. In this step, droplet operations electrodes 1410 in the path between reservoir electrode 1412 and magnet 1416 are turned off (inactive) and droplet operations electrodes 1410 in the path between magnet 1416 and waste reservoir electrode 1414 are activated. Deactivation and activation of droplet operations electrodes 1410 along the path to reservoir electrode 1414 pulls the slug of wash buffer 1424 across beads 1428 in sample droplet 1426. As wash buffer 1424 crosses beads 1428, unbound material, such as excess unbound reporter antibody, is transported in waste slug 1430.

FIG. 14D shows another step in a process of washing magnetically responsive beads in a washing cell. In this step, waste reservoir electrode 1414 is activated and droplet operations electrode 1410 that are immediately adjacent to magnet 1416 is turned off and waste slug 1430 is extended away front magnet 1416 to waste reservoir electrode 1414. Accumulating waste fluid is removed via opening 1420. The washing steps of FIGS. 14A through 14D may be repeated as necessary to provide for sufficient removal of unbound material.

In another embodiment, droplet operations electrodes 1410 may be activated such that a slug of wash buffer 1424 extends from wash reservoir electrode 1412 to waste reservoir electrode 1414 to provide for continuous washing of beads 1428 on magnet 1416. In this embodiment, liquid from wash reservoir 1412 is dispensed into the waste reservoir 1414 continuously so that while the beads are held over the magnet, the continuous flow of the liquid removes the supernatant. It should be noted that no droplets need to be formed in this approach.

It will be appreciated that the configuration may include more or less droplet operations electrodes 1410. Further, the path of droplet operations electrodes 1410 need not be organized in a straight line as shown, but may include bends or turns. Moreover, various intermediate steps may be included, such as using droplet operations electrodes 1410 to move droplet 1426 off of magnet 1416 to cause beads 1428 to be resuspended in the droplet and release any material that may be trapped between beads 1428. Other examples of suitable washing techniques are described in Pamula et al., U.S. Pat. No. 7,439,014, entitled “Droplet-Based Surface Modification and Washing,” granted on Oct. 21, 2008; and Allen et al., International Patent Application No., PCT/US2008/074151, entitled “Bead manipulations on a droplet actuator” filed on Aug. 25, 2008; the entire disclosures of which are incorporated herein by reference.

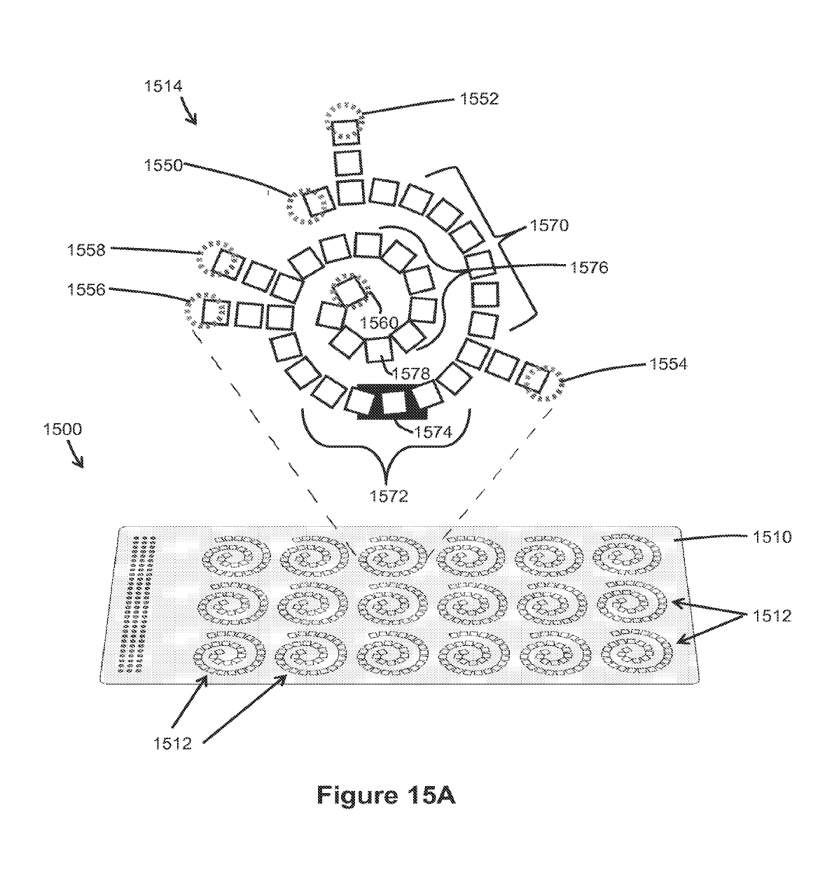

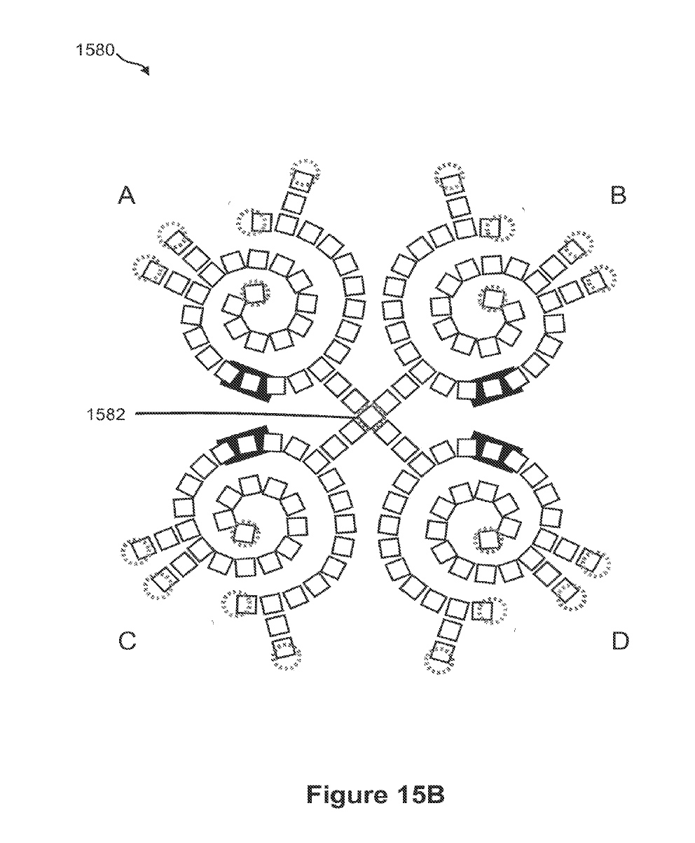

FIG. 15A is a perspective view of a portion of a droplet actuator 1500 that has spiral-shaped unit cells, and as an example, FIG. 15 shows a detail illustrating a spiral electrode layout 1514 for an immunoassay. Each spiral unit cell 1514 may be self-sufficient, similar to the self-sufficient unit cells of droplet actuator 1200 in FIG. 12. Alternatively, the spiral unit layouts may be interconnected by electrode arrangements (not shown) or other fluid paths.

Droplet actuator 1500 may include a bottom substrate 1510. Bottom substrate 1510 may include an arrangement of droplet operations electrodes 1512 that are configured for droplet operations. Droplet actuator 1500 may also include a top substrate (not shown) that is arranged in a generally parallel fashion with bottom substrate 1510, separated from bottom substrate 1510 to provide a gap for conducting droplet operations. Droplet operations electrodes 1512 may be arranged in a manner to form spiral-shaped unit cells 1514. In the example illustrated, droplet actuator 1500 includes 18 spiral-shaped unit cells 1514. Any number of such cells may be provided.

One or more openings may be provided in a top substrate for supplying sample and/or reagents to the spiral cells. As illustrated, opening 1550 may provide a fluid passage for loading a sample droplet; opening 1552 may provide a fluid passage for loading droplets including assay reagents or beads; opening 1554 may provide a fluid passage for loading a wash buffer; opening 1556 may provide an opening for removing waste from the spiral cell; opening 1558 may include an opening for adding reagent, such as substrate; opening 1560 may provide another opening for removing waste from the spiral cell.

Electrode path segment 1570 may be used for conducting droplet operations for mixing sample and reagent loaded from openings 1550 and 1552. Reagent may, for example, include beads having affinity for a target substance possibly present in the sample droplet. Wash droplets may be introduced via opening 1554 subjected to a washing protocol in path segment 1572 and/or path segment 1570. A magnet 1574 may be associated with the spiral cell for immobilizing beads during the execution of a washing protocol. Waste from a washing protocol may be removed from the spiral cell via opening 1556. Reagents for an immunoassay protocol, such as substrate, may be introduced via opening 1558 and combined with the bead-containing droplet. Mixing of substrate and the washed-bead droplet may occur in path segment 1576. Detection of signal generated by the protocol may be effected on path 1576, e.g., at electrode 1578.

Each spiral-shaped unit cell 1514 may be self-sufficient and may be operated in parallel. Alternatively, various reservoirs my feed multiple spiral cells; as with other unit cell embodiments described herein, substrate 1510 may include paths or networks of additional electrodes connecting the spiral cells to each other and/or to common, reservoirs. In one example, a common wash reservoir (not shown) may be provided on the top substrate, such that one wash reservoir supplies the wash reservoir of all spiral-shaped unit cells 1514 with wash buffer via a common opening corresponding to opening 1554 in FIG. 15A.

The spiral cells may be reoriented, e.g., as shown by electrode arrangement 1580 in FIG. 15B, to facilitate sharing of reservoirs. In the embodiment shown, a central reservoir may dispense sample via opening 1582 for conducting four assay protocols on four spiral cells A, B, C and D, which are otherwise the same as the spiral cells 1514 described above.

A variety of configurations and protocols will be apparent to the skilled artisan in light of this specification. In one alternative embodiment, the process is reversed, so that sample is loaded via opening 1560 and waste is removed via opening 1550. On or more magnets may be provided at various locations around the spiral cell as needed for handling magnetically responsive beads, e.g., conducting merge-and-split droplet washing protocols.

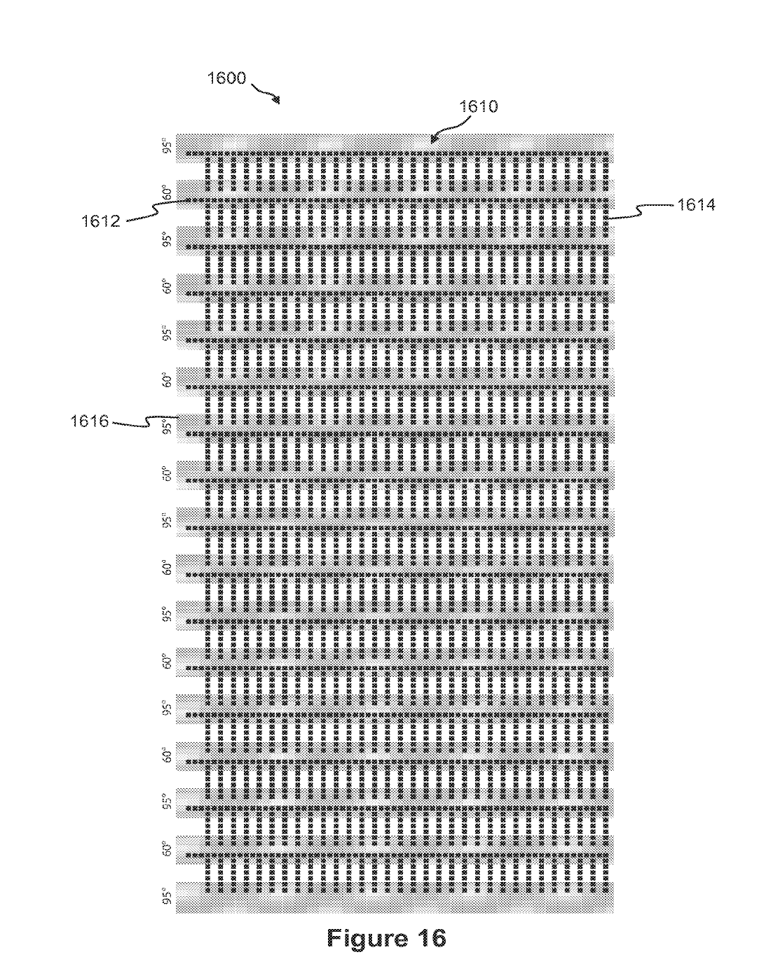

FIG. 16 illustrates a top view of a portion of a droplet actuator 1600 that is configured for real-time flow-through PCR. Droplet actuator 1600 is another example of a droplet actuator wherein each sample is processed separately (i.e., its own flow-through unit cell) in order to ensure that there is substantially no cross-contamination between samples.

Droplet actuator 1600 may include an arrangement of droplet operations electrodes 1610 (e.g., electrowetting electrodes) that are configured to provide, for example, 16 columns 1612. Each column 1612 may have, for example, 32 flow-through unit cells 1614. In this example, 16 columns 1612×32 flow-through unit cells 1614 results in 512 reactions. Each column 1612 may also include a sample reservoir (not shown) for loading 16 different samples. A sample loaded on a column 1612 may be dispensed and transported via droplet operations along the column 1612 such that each flow-through unit cell 1614 in the column 1612 is populated with sample.

Droplet operations electrodes 1610 may also be configured to include one or more reagents reservoirs (not shown) that are located, for example, opposite from the samples reservoirs of columns 1612. The arrangement of reagent reservoirs may be such that any combination of reagents may be routed to any combination of samples.

A set of heaters 1616 is aligned with and positioned in proximity to respective columns 1612. Heaters 1616 control the temperature of filler fluid in their vicinity. Heaters 1616 may provide two different thermal zones for each flow-through unit cell 1614. For example, heaters 1616 may provide a 95° C. zone and a 60° C. zone. Alternating the temperature provided by each heater 1616 (e.g., 95° C., 60° C., 95° C., 60° C., etc.) allows heaters to be shared between adjacent columns 1612. For example, during a PCR assay, a reaction sample in a flow-through unit cell 1614 is transported back and forth between a heater 1616 set at 95° C. and a heater 1616 set at 60° C.

In another embodiment, droplet actuator 1600 may be configured to provide any number of columns 1612 and flow-through cells 1614. In one example, droplet actuator 1600 may be configured to provide 12 columns 1612 and 32 flow-through unit cells 1614 (i.e., 384 reactions).

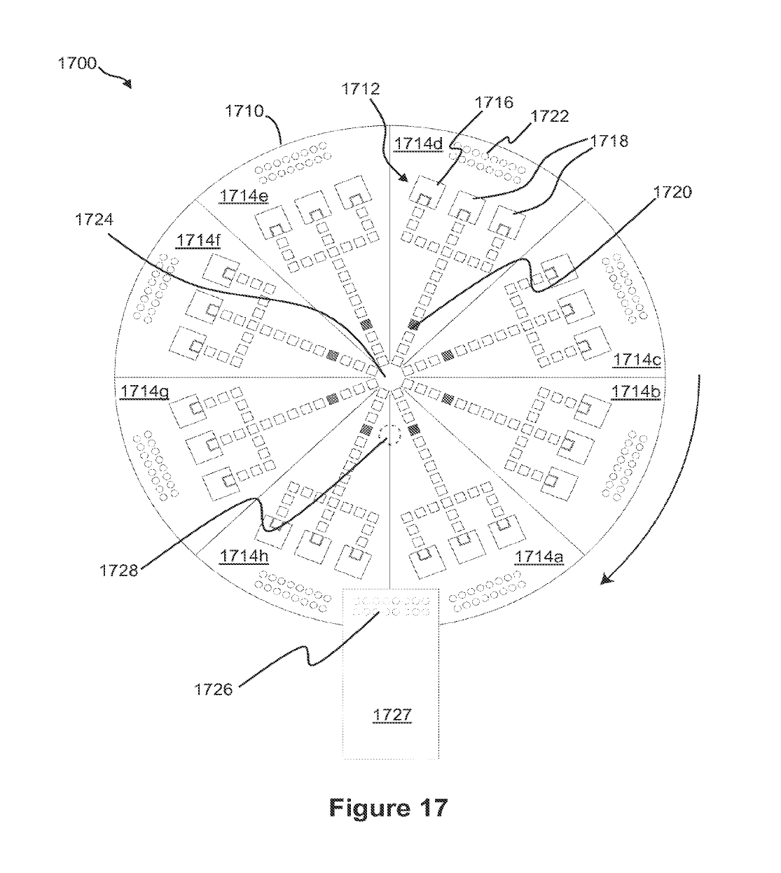

FIG. 17 illustrates a top view of a portion of a disk-shaped droplet actuator 1700 that has wedge-shaped unit cells. Droplet actuator 1700 is an example of a droplet actuator wherein each unit cell may be operated independently. Droplet actuator 1700 may include a bottom substrate 1710. Bottom substrate 1710 may include an arrangement of droplet operations electrodes 1712 that are configured for droplet operations. In one example, droplet operations electrodes 1712 may be arranged to provide, for example, 8 wedge-shaped unit cells 1714 (e.g., wedge-shaped unit cell 1714a through 1714h). Wedge-shaped unit cells 1714 may include a sample reservoir 1716, two reagent reservoirs 1718, and a detection electrode 1720. A waste reservoir 1724 may be positioned at the apex of wedge-shaped unit cells 1714 in the center of droplet actuator 1700. Waste reservoir 1724 is, therefore, common to all wedge-shaped unit cells 1714. Wedge-shaped unit cells 1714 also include contact pads 1722 for providing electrical connection to contacts on bottom substrate 1710.

Droplet actuator 1700 may be aligned with contact pins 1726 of a control instrument 1727 and detector configured to align with detection spot 1728 on disk-shaped droplet actuator 1700. Contact pins 1726 of control instrument 1727 provide for electrical connection to contact pads 1722 on bottom substrate 1710 that are associated with a certain wedge-shaped unit cell 1714. The relative positions of droplet actuator 1700 and control instrument 1727 may be adjustable in order to engage and disengage contact pads 1722 of droplet actuator 1700 and contact pins 1726 of control instrument 1727. In this way, droplet actuator 1700 may be rotated to bring any wedge-shaped unit cell 1714 into contact with control instrument 1727. When positioned, detection spot 1728 is aligned with detection electrode 1720 in wedge-shaped unit cell 1714 for detection of assay results.

In operation, a unit cell, for example, wedge-shaped unit cell 1714a is rotated or otherwise moved into position such that contact pads 1722 associated with wedge-shaped unit cell 1714a and contact pins 1726 of control instrument 1727 are aligned. Alternatively, contact pins 1726 of control instrument 1727 may be moved into alignment with contact pads 1722 associated with wedge-shaped unit cell 1714a. Contact pads 1722 and contact pins 1726 are engaged to provide an electrical connection to wedge-shaped unit cell 1714a. In this position, detection spot 1728 is aligned with detection electrode 1720 of wedge-shaped unit cell 1714a. Sample and reagents are dispensed and an assay is performed using droplet operations. Following die detection operation for determining the assay results and dispensing of waste droplets in waste reservoir 1724, contact pins 1726 of control instrument 1727 are disengaged from contact pads 1722 of wedge-shaped unit cell 1714a. Droplet actuator 1700 is rotated (e.g., clockwise in direction of arrow) such that wedge-shaped unit cell 1714a is moved away from contact pins 1726 of control instrument 1727. Subsequently, the contact pads 1722 associated with wedge-shaped unit cell 1714b are moved into position and are engaged with contact pins 1726 of control instrument 1727. Wedge-shaped unit cell 1714b is now electrically coupled with control instrument 1727 and ready for operation. The process may be repeated until all eight wedge-shaped unit cells 1714 have been assayed. This invention takes advantage of the radial symmetry of droplet actuator 1700. In another embodiment, the detector can be a CCD camera overlooking all the droplets at the center of the droplet actuator. Multiple droplets can be detected simultaneously with the CCD camera within a small area. The wedge shaped unit cell design forming a circular droplet actuator would avoid common paths being used for incubation washing and detection.

In one embodiment, each wedge-shaped unit cell 1714 is configured to perform an assay on different samples. In another embodiment, each wedge-shaped unit cell 1714 is configured to perform a different assay on the same sample (e.g., dispensed from individual sample reservoirs in each unit cell). In yet another embodiment, a single sample reservoir may be used to dispense a sample droplet to each wedge-shaped unit cell 1714 that is configured to perform a different molecular assay. In another embodiment, the centrifugal forces generated during operation of the circular disk can be used to perform separations in the samples, such as separation of cells from whole blood.

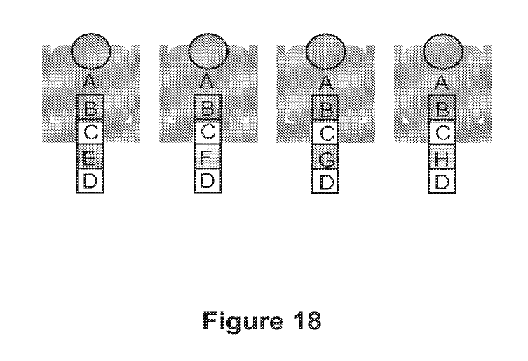

FIG. 18 illustrates an embodiment of the invention including providing multiplexed electrode configurations with gating electrodes. The principle is illustrated with a dispensing configuration, but it will be appreciated that it will be applicable in any droplet operations setting in which it is desirable for droplet operations to proceed in some lanes or regions of a multiplexed droplet actuator while the same droplet operations do not proceed in other lanes or regions of the droplet actuator. The dispensing configuration makes use of a set of multiplexed dispensing electrodes A, B, C, and D, and a set of gating electrodes E, F, G, and H. The configuration facilitates the use of a simpler, multiplexed wiring scheme, while providing the dispensing flexibility of a system that is not multiplexed. In the example shown: (a) multiplexed dispensing electrodes A are wired together as a set and are activated/deactivated together; (b) multiplexed dispensing electrodes B are wired together as a set and are activated/deactivated together; (c) multiplexed dispensing electrodes C are wired together as a set and are activated/deactivated together; and (d) multiplexed dispensing electrodes D are wired together as a set and are activated/deactivated together. Gating electrodes E, F, G, and H are operated independently. Thus, in a dispensing operation for dispensing a droplet from the first dispensing configuration, electrodes A, B, C, E and D may be activated. The fluid will form a finger on all configurations through electrode C, but it will extend to electrode D only on the first configuration because electrode E is activated, while electrodes F, G, and H remain deactivated. Electrode E may then be deactivated to dispense a droplet on electrode D of the first configuration. Using this technique, droplets may be produced on any or all of the electrode configurations as needed. In one aspect of the invention, different unit cells may include one or more independently controlled gating electrodes which can be used to independently prevent or allow a droplet operation within that unit cell. This would assist in performing multiplexed droplet operations using minimal number of control channels which is useful in both point of care applications where size of droplet actuator matters and also in research applications where a large number of assays can be performed with fewer number of control channels. Each dispensing reservoir can be wired with any of the reservoir in order to minimize the number of control channels. For example, for a droplet actuator that performs immunoassays, a reagent reservoir can be wired with a chemiluminescent substrate reservoir and the gate electrodes can be made independent resulting in minimal number of control channels to perform an immunoassay. Such an embodiment would require less complicated electronics, fewer electrodes resulting in a smaller droplet actuator.

### 6.4.1 Stat Digital Microfluidic Cartridge

The present invention also provides a stat digital microfluidic cartridge. In a stat lab environment, there may be a need to run multiple samples at once or to just run one sample with a very high priority. Currently, once a cartridge is filled with oil and other fluids it is difficult to save the cartridge for future use. Thus, if one urgent sample comes in, the operator may have to waste an entire cartridge (which could be designed for multiple samples) to get an immediate result.

It is contemplated herein for a cartridge with separate chambers or unit cells that allow for stat capabilities. Each chamber would be isolated so that it can be filled with oil separately without impacting other chambers on the same cartridge. The cartridge could be designed to have one stat chamber per cartridge. For example, if you have a ten sample cartridge, one could be a stat lane where the other nine are all in an open environment as currently performed. In another example, the cartridge could be designed so that each sample lane or area is a stat chamber, i.e., all ten samples could be processed independently in a stat methodology.

Chambers could be provided on the cartridge by extending gasket features into the interior of the cartridge to provide isolated regions where oil or other filler fluids are contained without impacting adjacent chambers in the cartridge. Since current procedures use plastic injection molded parts where features can be easily added and current assembly procedures use automation to dispense adhesives, the concept could be implemented in a cost effective manner.

The use of a stat digital microfluidic cartridge enables stat processing of samples in a cost effective manner. Instead of wasting an entire multi-sample cartridge, tire user can either use the stat lane or pull out a special stat cartridge that is designed for use in the stat environment. The user can utilize portions of a cartridge and then save the rest of the cartridge for later use. It is also preferred over using a smaller, single sample cartridge since the multi-chamber version can be made to the same footprint. This aspect allows the use of automation in both the manufacture and use of the cartridge.

### 7 CONCLUDING REMARKS

The foregoing detailed description of embodiments refers to the accompanying drawings, which illustrate specific embodiments of the invention. The scale of the drawings set forth herein is not intended to limit the scope of the invention. Other embodiments having different structures, operations and scales do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

We claim:

1-242. (canceled)

243. A droplet actuator comprising:
(a) a substantially disk-shaped droplet operations substrate;
(b) droplet operations electrodes arranged in radially oriented paths on the substrate to provide wedge-shaped unit cells, wherein the droplet operations electrodes are configured for conducting droplet operations on a surface of the substrate;
(c) one or more reservoirs associated with the wedge-shaped unit cells; and
(d) contact pads associated with the wedge-shaped unit cells and configured for providing electrical connections to the droplet operations electrodes arranged thereon.

244. The droplet actuator of claim 243, wherein the wedge-shaped unit cells are configured to operate independently of one another.

245. The droplet actuator of claim 243, wherein the one or more reservoirs comprise one or more sample reservoirs, reagent reservoirs, wash reservoirs, and/or waste reservoirs.

246. The droplet actuator of claim 245, wherein one or more of the wedge-shaped unit cells further comprises at least one of a sample reservoir, a reagent reservoir, and/or a wash reservoir.

247. The droplet actuator of claim 243, further comprising one or more detection electrodes associated with one or more of the wedge-shaped unit cells.

248. The droplet actuator of claim 245, wherein at least one of the one or more waste reservoirs is positioned at an apex of the wedge-shaped unit cells in a center region of the droplet operations substrate.

249. The droplet actuator of claim 248, wherein the at least one of the one or more waste reservoirs positioned at the apex of the wedge-shaped unit cells in the center region of the droplet operations substrate is common to all wedge-shaped unit cells.

250. An instrument comprising:
(a) the droplet actuator of claim 243;
(b) a detector configured to detect a signal from a droplet at the one or more detection electrodes; and
(c) contact pins configured for providing electrical connection to contact pads on the droplet operations substrate that are associated with a certain wedge-shaped unit cell when engaged therewith.

251. The instrument of claim 250, wherein the droplet operations substrate is configured such that contact pads and detection electrode associated with a wedge-shaped unit cell are capable of being aligned with the contact pins and detector.

252. The instrument of claim 250, wherein the droplet operations substrate is configured such that contact pads and detection electrode associated with at least one wedge-shaped unit cell are capable of being aligned with the contact pins and detector.

253. The instrument of claim 250, wherein the positions of the droplet actuator and/or instrument is adjustable in order to engage and/or disengage the contact pads of droplet operations substrate with the contact pins of the instrument.

254. The instrument of claim 252, wherein the position of the droplet actuator is adjusted by rotating the droplet actuator.

255. The instrument of claim 252, wherein the position of the instrument is adjusted by rotating the instrument about the droplet actuator.

256. The instrument of claim 250, wherein the detector comprises a CCD camera.

257. A method of conducting one or more droplet operations, comprising:
(a) providing the instrument of claim 250;
(b) moving one of the wedge-shaped unit cells and/or the instrument into position such that the contact pads associated with a desired wedge-shaped unit cell are engaged with the contact pins of the instrument and the detection electrode of the wedge-shaped unit cell is aligned with the detector of the instrument;
(c) dispensing one or more sample droplets and one or more assay specific reagent droplets from the one or more reservoirs associated with the wedge-shaped unit cell onto the droplet operations electrodes of the wedge-shaped unit cell;
(d) conducting a desired assay; and
(e) detecting the assay results at the detection electrode via the detector.

258. The method of claim 257, further comprising dispensing of waste droplets from the conducted assay in a waste reservoir associated with the wedge-shaped unit cell.

259. The method of claim 257, further comprising disengaging the contact pins of the instrument from the contact pads of the wedge-shaped unit cell.

260. The method of claim 259, further comprising rotating the droplet actuator and/or moving the instrument such that the wedge-shaped unit cell is moved away from the contact pins of the instrument and disengaged therefrom.

261. The method of claim 260, further comprising further rotating the droplet actuator and/or moving the instrument such that the contact pads associated with a next wedge-shaped unit cell is moved into position and are engaged with the contact pins of the instrument electrically coupling the instrument with the next wedge-shaped unit cell.

262. The method of claim 257, wherein each of the wedge-shaped unit cells are configured to perform an assay on different samples.

263. The method of claim 257, wherein each of the wedge-shaped unit cells are configured to perform a different assay on a same sample.

264. The method of claim 257, wherein a single sample reservoir is configured to dispense a sample droplet to each of the wedge-shaped unit cells that are configured to perform a different molecular assay.

265. The method of claim 257, wherein centrifugal forces generated during operation of the disk-shaped droplet operations substrate of the droplet actuator is used to perform separations in a sample.

266. The method of claim 265, wherein the separations comprise separation of cells from whole blood samples.
